(19) United States
(12) Patent Application Publication
(10) Pub. No.: US 2024/0055689 A1
(43) Pub. Date: Feb. 15, 2024

(54) COOLANT MANIFOLD SYSTEM FOR A BATTERY OF AN ELECTRIC VEHICLE

(71) Applicant: Taiga Motors Inc., LaSalle (CA)

(72) Inventors: Maan AL-ZAREER, Palo Alto, CA (US); Marc-Olivier GAGNON, Montreal (CA)

(73) Assignee: Taiga Motors Inc., LaSalle (CA)

(21) Appl. No.: 18/115,493

(22) Filed: Feb. 28, 2023

Related U.S. Application Data
(60) Provisional application No. 63/397,214, filed on Aug. 11, 2022.

(51) Int. Cl. H01M 10/625; H01M 10/6557; H01M 10/613; H01M 10/6568; H01M 50/204

(52) U.S. Cl. CPC H01M 10/625; H01M 10/6557; H01M 10/613; H01M 10/6568; H01M 50/204

(57) ABSTRACT

In one aspect, an electric vehicle comprises a plurality of battery modules, each of the battery modules having a respective coolant inlet, a coolant source, and a coolant inlet manifold configured to supply coolant from the coolant source to each of the plurality of coolant inlets in parallel. The manifold includes a coolant supply conduit, a plurality of branch conduits branching from the coolant supply conduit, and a plurality of flow restrictors. Each of the branch conduits is fluidically coupled to the coolant inlet of an associated respective one of the battery modules. Each of the flow restrictors restricts coolant flow to a respective subset of the branch conduits. In another aspect, the manifold includes a primary conduit, a plurality of secondary conduits branching from the primary conduit, and for each of the secondary conduits, a plurality of tertiary conduits branching from the secondary conduit.

### CROSS-REFERENCE TO RELATED APPLICATIONS

The present application claims the benefit of prior U.S. provisional application Ser. No. 63/397,214 filed Aug. 11, 2022, the contents of which are hereby incorporated by reference hereinto.

### TECHNICAL FIELD

The present disclosure relates to electric vehicles, and more particularly to a coolant manifold system for a battery of an electric vehicle.

### BACKGROUND

Electric powersport vehicles, such as electric snowmobiles, electric personal watercraft (PWCs), utility task vehicles (UTVs), and electric all-terrain vehicles (ATVs), constitute an environmentally attractive alternative to powersport vehicles powered by internal combustion engines. Electric powersport vehicles may be powered by a battery system (or simply “battery”) comprising multiple battery modules. A battery module may include a set of electrically interconnected battery cells along with a cooling structure configured to channel a liquid coolant (or, more generally, a heat transfer fluid) through the battery module for thermally regulating temperature of the battery cell(s). The flow of the liquid coolant may be controlled by a thermal management system. The thermal management system may be designed to keep a temperature of the battery cells within a desired operating temperature range during electric vehicle operation, in order to maximize battery efficiency.

### SUMMARY

In one aspect of the present disclosure, there is provided an electric vehicle comprising: a plurality of battery modules, each of the battery modules having a respective coolant inlet; a coolant source; a coolant inlet manifold configured to supply coolant from the coolant source to each of the plurality of coolant inlets in parallel, the coolant inlet manifold including: a coolant supply conduit terminating at a downstream end; a plurality of branch conduits branching from, and in fluid communication with, the coolant supply conduit, each of the branch conduits being fluidically coupled to the coolant inlet of a respective one of the battery modules; and a plurality of flow restrictors each restricting coolant flow to a respective subset of the branch conduits.

In some embodiments, the plurality of battery modules is arranged in a row.

In some embodiments, each of the flow restrictors is disposed in the coolant supply conduit.

In some embodiments, each of the flow restrictors restricts coolant flow to the respective subset of the branch conduits branching from the coolant supply conduit downstream of the flow restrictor.

In some embodiments, each of the flow restrictors, excluding a downstream-most one of the flow restrictors, directs a portion of the coolant flow to a respective one of the branch conduits branching from the coolant supply conduit upstream of the flow restrictor.

In some embodiments, each of the flow restrictors is configured to restrict a flow of liquid coolant to a respective extent and the extent to which each of the flow restrictors is configured to restrict the flow of liquid coolant monotonically increases in the downstream direction along the coolant supply conduit.

In some embodiments, one of the plurality of flow restrictors is configured to restrict liquid coolant flow into or through a downstream-most one of the branch conduits at the downstream end of the coolant supply conduit and each of a remainder of the flow restrictors is configured to restrict liquid coolant flow in the coolant supply conduit immediately downstream of a respective other one of the branch conduits.

In some embodiments, the downstream-most one of the branch conduits comprises a branch portion of an end fitting and the one of the plurality of flow restrictors is disposed in a tubular portion of the end fitting upstream of the branch portion of the end fitting.

In some embodiments, the end fitting is a 90-degree elbow fitting.

In some embodiments, for each of the remainder of the flow restrictors: the flow restrictor defines a constricted passage in the coolant supply conduit immediately downstream of a respective one of the branch conduits; and the coolant supply conduit defines an unconstricted passage immediately upstream of the respective one of the branch conduits, a cross-sectional area of the constricted passage being smaller than a cross-sectional area of the unconstricted passage.

In some embodiments, each of the flow restrictors is disposed in, and restricts liquid coolant flow through, a respective one of the branch conduits.

In some embodiments, the extent to which each of the flow restrictors is configured to restrict liquid coolant flow monotonically decreases in the downstream direction along the coolant supply conduit.

In some embodiments, the coolant supply conduit is substantially straight.

In some embodiments, each of the branch conduits is substantially orthogonal to the coolant supply conduit.

Embodiments may include combinations of the above features.

In another aspect of the present disclosure, there is provided an electric vehicle comprising: a plurality of battery modules, each of the battery modules having a respective coolant inlet, the plurality of battery modules being grouped in multiple groups of at least two battery modules per group; a coolant source; a coolant inlet manifold configured to supply coolant from the coolant source to each of the plurality of coolant inlets in parallel, the coolant inlet manifold including: a primary conduit in fluid communication with the coolant source; a plurality of secondary conduits branching from, and in fluid communication with, the primary conduit, each of the secondary conduits being associated with a respective one of the groups of battery modules; and for each of the secondary conduits, a plurality of tertiary conduits branching from, and in fluid communication with, the secondary conduit, each of the tertiary conduits of the plurality being fluidically coupled with the coolant inlet of a respective one of the battery modules of the group with which the secondary conduit is associated.

In some embodiments, the plurality of battery modules is arranged in a row.

In some embodiments, each group of battery modules is a distinct, contiguous plurality of battery modules within the row.

In some embodiments, for each of the secondary conduits, the tertiary conduits branching from the secondary conduit are each substantially orthogonal to the secondary conduit.

In some embodiments, the plurality of secondary conduits comprises two secondary conduits and the primary conduit is fluidically coupled to the two secondary conduits via a splitter.

In some embodiments, the splitter is configured to divide fluid flow from the primary conduit substantially evenly between the two secondary conduits.

In some embodiments, for each of the secondary conduits, the plurality of tertiary conduits branching from the secondary conduit comprises two tertiary conduits and the secondary conduit is fluidically coupled to the two tertiary conduits via a splitter.

In some embodiments, for each of the secondary conduits, the splitter is configured to divide fluid flow from the secondary conduit substantially evenly between the two tertiary conduits.

In some embodiments, the primary conduit is a primary supply conduit, each of the secondary conduits is a secondary supply conduit, each of the tertiary conduits is a tertiary supply conduit, each of the plurality of battery modules has a respective coolant outlet, and the electric vehicle further comprises: a coolant sink; a coolant outlet manifold configured to channel liquid coolant to the coolant sink from each of the plurality of coolant outlets in parallel, the coolant outlet manifold including: a primary return conduit in fluid communication with the coolant sink; a plurality of secondary return conduits branching from, and in fluid communication with, the primary return conduit, each of the secondary return conduits being associated with a respective one of the groups of battery modules; and for each of the secondary return conduits, a plurality of tertiary return conduits branching from, and in fluid communication with, the secondary return conduit, each of the tertiary return conduits of the plurality being fluidically coupled with the coolant outlet of a respective one of the battery modules of the group with which the secondary return conduit is associated.

Embodiments may include combinations of the above features.

In another aspect of the present disclosure, there is provided an electric vehicle comprising: a plurality of battery modules, each of the battery modules having a respective coolant inlet; a coolant source; a coolant inlet manifold configured to supply coolant from the coolant source to each of the plurality of coolant inlets in parallel, the coolant inlet manifold including: a primary conduit in fluid communication with the coolant source; a plurality of secondary conduits fluidically coupled to the primary conduit via a first splitter; and for each of the secondary conduits, a plurality of tertiary conduits fluidically coupled to the secondary conduit via a respective second splitter, each of the tertiary conduits of the plurality being fluidically coupled with the coolant inlet of a respective one of the battery modules.

In some embodiments, each of the flow restrictors is disposed in, and restricts the coolant flow through, a respective one of the branch conduits.

In some embodiments, the cross-sectional area of the constricted passage is less than half of the cross-sectional area of the unconstricted passage.

In some embodiments, the constricted passage and the unconstricted passage are defined by respective parts of a run portion of a through fitting.

In some embodiments, each of the branch conduits defines a passage with a flattened cone shape.

In some embodiments, the number of battery modules per group is no greater than four.

In some embodiments, the number of battery modules per group is no greater than three.

In some embodiments, the number of battery modules per group is no greater than two.

In a further aspect of the present disclosure, there is provided a thermal management system for a battery having a plurality of battery modules arranged in a row, each of the battery modules having a respective coolant inlet, the thermal management system comprising: a coolant source; a coolant inlet manifold configured to supply coolant from the coolant source to each of a plurality of coolant inlets in parallel, the coolant inlet manifold including: a coolant supply conduit terminating at a downstream end; a plurality of branch conduits branching from, and in fluid communication with, the coolant supply conduit, each of the branch conduits being fluidically coupled to the coolant inlet of an associated respective one of the battery modules; and a plurality of flow restrictors each restricting coolant flow to a respective subset of the branch conduits.

In yet another aspect of the present disclosure, there is provided a thermal management system for a battery having a plurality of battery modules arranged in a row, each of the battery modules having a respective coolant inlet, and the plurality of battery modules being grouped in multiple groups of at least two battery modules per group, the thermal management system comprising: a coolant source; a coolant inlet manifold configured to supply coolant from the coolant source to each of the plurality of coolant inlets in parallel, the coolant inlet manifold including: a primary conduit in fluid communication with the coolant source; a plurality of secondary conduits branching from, and in fluid communication with, the primary conduit, each of the secondary conduits being associated with a respective one of the groups of battery modules; and for each of the secondary conduits, a plurality of tertiary conduits branching from, and in fluid communication with, the secondary conduit, each of the tertiary conduits of the plurality being fluidically coupled with the coolant inlet of a respective one of the battery modules of the group with which the secondary conduit is associated.

### BRIEF DESCRIPTION OF THE DRAWINGS

In the figures which illustrate example embodiments,

FIG. 1 is a side plan view of an electric vehicle;

FIG. 2 is an isometric view of a portion of the powertrain of the electric vehicle of FIG. 1;

FIG. 3 is an isometric view of a battery system of the electric vehicle of FIG. 1;

FIG. 4 is a schematic diagram of a logical (hierarchical) structure of the battery system of FIG. 3;

FIG. 5 is a simplified perspective view of a battery module of the battery system of FIG. 3;

FIG. 6 is a perspective view of a coolant inlet manifold and a coolant outlet manifold of the electric vehicle of FIG. 1;

FIG. 7 is an isometric view of a portion of the coolant inlet manifold of FIG. 6;

FIGS. 8A, 8B, and 8C are different views of a through fitting of the coolant inlet manifold of FIG. 6;

FIG. 8D is a cross-section of the through fitting of FIG. 8A;

FIGS. 9A, 9B, and 9C are different views of an end fitting of the coolant inlet manifold of FIG. 6;

FIG. 9D is a cross-section of the end fitting 400 of FIG. 9A;

FIG. 10 is an isometric view of a portion of a passage defined by the coolant inlet manifold of FIG. 6;

FIG. 11 is a top view of an alternative coolant inlet manifold;

FIG. 12 is a cross section of a first restricted through fitting component of the coolant inlet manifold of FIG. 11;

FIG. 13 is a cross section of a second restricted through fitting component of the coolant inlet manifold of FIG. 11;

FIG. 14 is a cross section of a restricted end fitting component of the coolant inlet manifold of FIG. 11;

FIG. 15 is a side elevation view of another coolant manifold system including an alternative coolant inlet manifold and an alternative coolant outlet manifold;

FIG. 16 is an isometric view of a through fitting component of the coolant inlet manifold of FIG. 15;

FIG. 17 is an isometric view of an elbow fitting component of the coolant inlet manifold of FIG. 15;

FIG. 18 is a side elevation view of the alternative coolant inlet manifold of FIG. 15 emphasizing its hierarchical structure;

FIG. 19 is a side elevation view of the alternative coolant outlet manifold of FIG. 15 emphasizing its hierarchical structure.

FIG. 20 is an isometric view of an alternative battery system of the electric vehicle of FIG. 1 with an associated further alternative coolant manifold system;

FIG. 21A is an isometric view of a three-way junction fitting of the coolant manifold system of FIG. 20;

FIG. 21B is a cross-section of the three-way junction fitting of FIG. 21A;

FIG. 22 is an perspective view of a portion of the coolant manifold system of FIG. 20;

FIG. 23A is an isometric view of a reducer through fitting used in the coolant manifold system portion illustrated in FIG. 22;

FIG. 23B is a cross-section of the reducer through fitting of FIG. 23A;

FIG. 24A is an isometric view of another reducer through fitting used in the coolant manifold system portion illustrated in FIG. 22;

FIG. 24B is a cross-section of the reducer through fitting of FIG. 24A;

FIG. 25 is a side elevation view of a coolant inlet manifold of the coolant manifold system portion of FIG. 22 emphasizing its hierarchical structure;

FIG. 26 is a side elevation view of a coolant outlet manifold of the coolant manifold system portion of FIG. 22 emphasizing its hierarchical structure;

FIG. 27 is a perspective view of another electric vehicle;

FIG. 28 depicts a system of passages defined by the coolant manifold system of the electric vehicle of FIG. 27;

FIG. 29 is a perspective view of a two pairs of coolant inlet manifolds and coolant outlet manifolds of the coolant manifold system of FIG. 28;

FIG. 30 is a perspective view of another two pairs of coolant inlet manifolds and coolant outlet manifolds of the coolant manifold system of FIG. 28;

FIG. 31 is an orthogonal view of an alternative battery system of the electric vehicle of FIG. 27 with an associated coolant manifold system; and

FIG. 32 is an isometric view of a wye junction fitting comprising the coolant manifold system of FIG. 31.

### DESCRIPTION

In this document, any use of the term “exemplary” should be understood to mean “an example of” and not necessarily to mean that the example is preferable or optimal in some way. Terms such as “top,” “bottom,” “left,” and “right” may be used to describe features of some embodiments in this description but should not be understood to necessarily connote an orientation of the embodiments during manufacture or use.

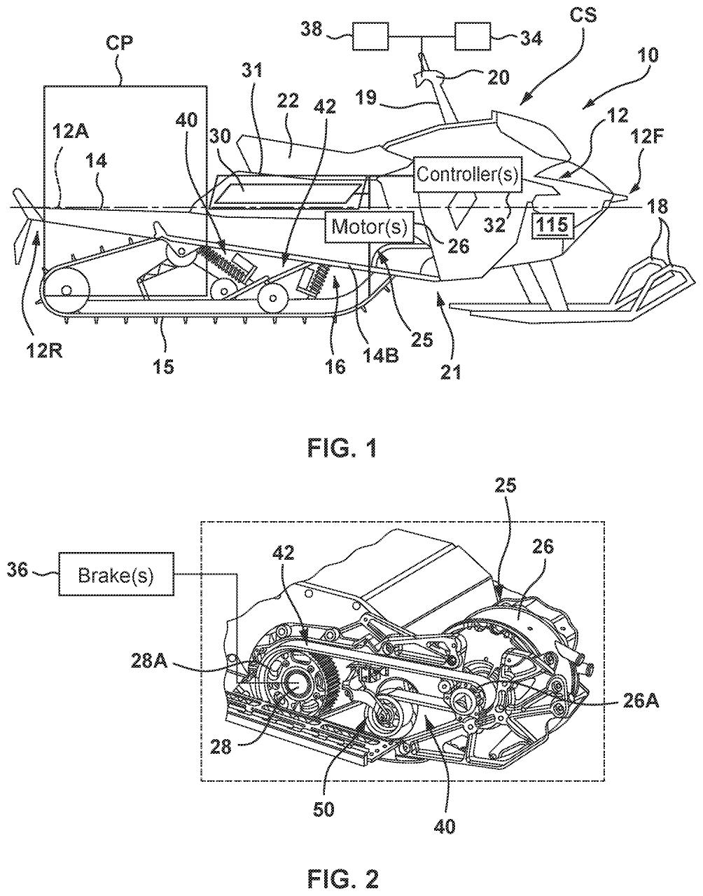

FIG. 1 is a side plan view of an electric vehicle 10 embodying aspects of the present disclosure. The electric vehicle 10 of FIG. 1 is a snowmobile, which is a form of electric powersport vehicle. In alternative embodiments, the electric vehicle 10 may be another type of electric vehicle that may or may not be an electric powersport vehicle. Non-limiting examples of other types of electric vehicles include electric on-road vehicles (e.g., cars, trucks, vans, and sport utility vehicles (SUVs)) and electric off-road vehicles (e.g., UTVs, ATVs, and watercrafts including PWCs).

In some embodiments, the electric vehicle 10 includes elements of the snow vehicles described in International Patent Application no. PCT/IB2018/056940 entitled “Battery arrangement for electric snow vehicles”, and/or in U.S. patent application Ser. No. 17/569,803 entitled “Electric vehicle with battery pack as a structural element”, the entirety of each of which is incorporated by reference into the present disclosure.

The electric vehicle 10 may include a body 12 (also known as a frame or a chassis) which may include a tunnel 14, a drive track 15 having the form of an endless belt for engaging the ground (e.g., snow) and disposed under the tunnel 14, and a powertrain 16 mounted to the body 12 and configured to displace the drive track 15. Left and right skis 18 are disposed in a front portion of the electric vehicle 10, and a straddle seat 22 is disposed above the tunnel 14 for accommodating an operator of the electric vehicle 10 and optionally one or more passengers. The left and right skis 18 may be movably attached to the body 12 to permit steering of the electric vehicle 10 via a steering assembly including a steering column 19 connected to a handle 20 or handlebars.

The body 12 and at least some of its components extend along a longitudinal axis 12A between a front end 12F of the body 12 and a rear end 12R of the body 12. The longitudinal axis 12A is a center axis of the body 12. The body 12 also defines a center plane CP (partially shown in FIG. 1) being an upright plane containing the longitudinal axis 12A. The center plane CP divides the body 12 into two equal lateral sides (e.g., left and right sides of the electric vehicle 10). The front and rear ends 12F,12R are defined with respect to the direction of travel of the electric vehicle 10, in that the front end 12F is the end of the body 12 that faces toward the forward direction of travel of the electric vehicle 10. Similarly, the rear end 12R is the end of the body 12 that faces toward the aft or reverse direction of travel of the electric vehicle 10.

FIG. 2 is an isometric view of a portion of the powertrain 16 of the electric vehicle 10. Referring to FIGS. 1 and 2, the powertrain 16 includes an electric motor assembly 25. The electric motor assembly 25 is a collection of components and features which function to deliver an electric drive to displace the electric vehicle 10. The electric motor assembly 25 includes at least one electric motor 26 drivingly coupled to the drive track 15 via a drive shaft 28. The electric motor 26 may be or include a permanent magnet synchronous motor. In one embodiment, the electric motor 26 has a maximum output power of between 120 and 180 horsepower. In other embodiments, the electric motor 26 has a maximum output power of at least 180 horsepower. The drive shaft 28 may be drivingly coupled to the drive track 15 via one or more toothed wheels or other means so as to transfer motive power from the electric motor 26 to the drive track 15.

The powertrain 16 includes at least one battery system 30 for providing electric energy (i.e., electric current) to the electric motor 26 and driving the electric motor 26. The battery system 30 may also be referred to as a “battery pack” or simply a “battery.” In some embodiments, the battery system 30 of the electric vehicle 10 may include lithium ion or other types of battery cells. The battery system 30 is housed in a battery enclosure 31. The battery enclosure 31 is a housing which defines an inner volume in which the battery system 30 is located and sealed-off from an environment external to the battery enclosure 31. The battery enclosure 31 is an elongated and at least partially hollow component which extends in a direction parallel to a length of the body 12.

With continued reference to FIGS. 1 and 2, the electric motor assembly 25 may be disposed in a mid-bay 21 of the electric vehicle 10, which is forward of the tunnel 14. A front wall of the tunnel 14 may form a rear wall of the mid-bay 21. The electric motor assembly 25 may also be disposed below the battery enclosure 31 in the mid-bay 21. The battery enclosure 31 is disposed at least partially between the tunnel 14 and the straddle seat 22 and may extend into the mid-bay 21. In other embodiments, the electric motor assembly 25 and/or battery system 30 may disposed in other positions within the electric vehicle 10.

The operation of the electric motor 26 and the delivery of drive current to the electric motor 26 from the battery system 30 may be controlled by a controller 32 based on an actuation of an input device 34, sometimes referred to as an “accelerator” or “throttle”, by the operator. The controller 32 and the input device 34 are part of a control system CS for controlling operation of the electric vehicle 10.

The electric motor 26 is in torque-transmitting engagement with the drive shaft 28 via a transmission 40. The transmission 40 may be of a belt/pulley type, a chain/sprocket type, or a shaft/gear type for example. Referring to FIG. 2, the transmission 40 is of a belt/pulley type. The transmission 40 includes a drive belt 42 that is mounted about a motor output 26A of the electric motor 26 and is also mounted about a drive track wheel 28A for driving the drive shaft 28. The drive belt 42 therefore extends between the motor output 26A and the drive track wheel 28A for conveying torque from the electric motor 26 to the drive shaft 28. The drive shaft 28 provides torque to the drive track 15. The drive belt 42 is thus displaced or driven by the motor output 26A in a linear manner between the motor output 26A and the drive track wheel 28A, and in a circumferential manner about the motor output 26A and the drive track wheel 28A. In the illustrated example, the transmission 40 has a drive belt tensioner 50 to apply tension to part of the drive belt 42. In an embodiment, the transmission 40 is free of the drive belt tensioner 50.

In FIG. 2, the electric motor 26 and the drive shaft 28 are horizontally spaced apart from each other along the length of the electric vehicle 10. The powertrain 16 may also have any other suitable orientation to displace the drive track 15. For example, in another embodiment of the powertrain 16, the electric motor 26 and the drive shaft 28 are vertically spaced apart from each other.

The electric vehicle 10 may also include one or more brake(s) 36 (referred hereinafter in the singular) that may be applied or released by an actuation of a brake actuator (e.g., lever) 38 by the operator for example. The brake 36 may be operable as a main brake for the purpose of slowing and stopping the electric vehicle 10 during motion of the electric vehicle 10. The brake 36 may comprise a combination of tractive braking and regenerative braking. Alternatively or in addition, the brake 36 may be operable as a parking brake, sometimes called “e-brake” or “emergency brake”, of the electric vehicle 10 intended to be used when the electric vehicle 10 is stationary.

The electric vehicle 10 further includes a thermal management system 115 for controlling the temperature of various components of the electric vehicle 10, including the battery system 30 and the electric motor 26, for example. The thermal management system 115 is discussed in further detail elsewhere herein.

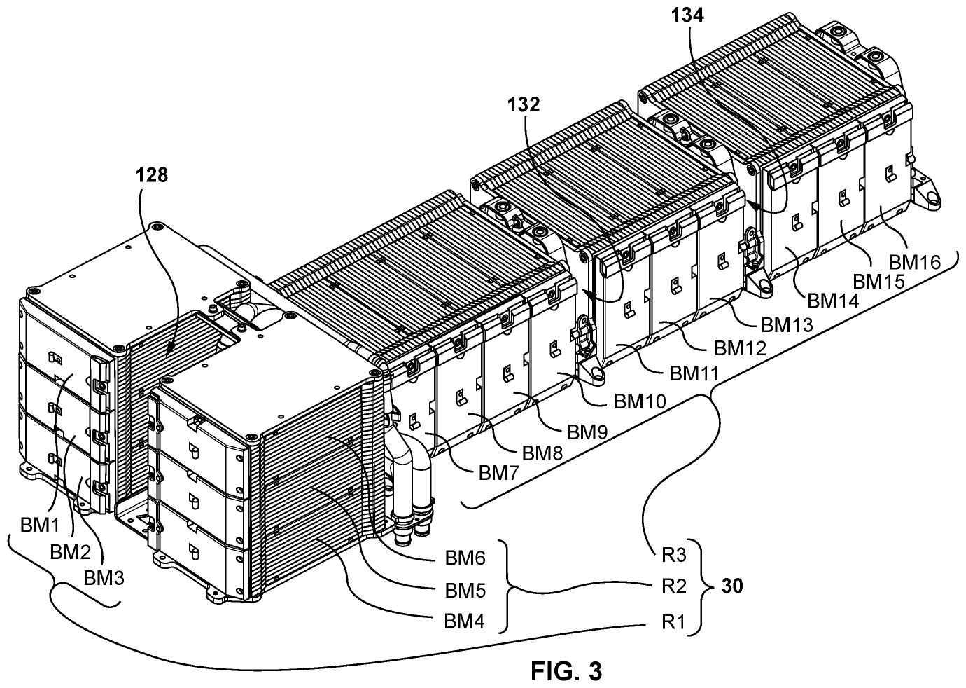

FIG. 3 is a top left isometric view of the battery system 30 of electric vehicle 10 in isolation from other vehicle components. The battery enclosure 31 is removed in FIG. 3 to show the internal components of the battery system 30. The physical structure (e.g., size and shape) of battery system 30 is configured to fit within the body of the snowmobile embodiment of electric vehicle 10 depicted in FIG. 1. The battery systems of other electric vehicles may have a different physical structure.

The example battery system 30 includes sixteen battery modules BM1-BM16 that are generally arranged in three distinct rows, which may alternatively be referred to as columns, or stacks. A first battery module row R1 includes battery modules BM1-BM3 which are stacked vertically. A second battery module row R2 includes battery modules BM4-BM6, also stacked vertically. A third battery module row R3 includes battery modules BM7-BM16 stacked horizontally along the longitudinal axis 12A (FIG. 1). Each of the battery module rows R1, R2 is a vertically oriented row of battery modules, and the battery module row R3 is a horizontally oriented row of battery modules. Further, the battery module rows R1, R2 may be referred to as mid-bay battery module rows as they are generally positioned within or above the mid-bay 21 of the electric vehicle 10. The battery module row R3 may be referred to as a tunnel battery module row as it is generally positioned above the tunnel 14 of the electric vehicle 10. A gap 128 separates the two battery module rows R1 and R2. The gap 128 accommodates the steering column 19 to which the handle 20 of the electric vehicle 10 is attached (see FIG. 1). It will be appreciated that the gap 128 is not necessarily present in alternative battery embodiments.

The battery modules in each of the battery module rows R1, R2, and R3 are positioned side-by-side or adjacently such that surfaces of the battery modules are facing one another. The surfaces of two adjacent battery modules may be in contact or may be separated by other elements of the battery system 30, such as structural members, for example. By way of example, in the battery module row R3 the pair of battery modules BM9, BM10 are in contact with one another, whereas the pair of battery modules BM10, BM11 are separated by a gap 132 accommodating a mechanical support structure for the battery system 30. In another example, the pair of battery modules BM14, BM15 are in contact with one another, whereas the pair of battery modules BM13, BM14 are separated by a gap 134 accommodating a further mechanical support structure. It is noted that the gaps 132, 134 are optional and might not be included in other embodiments.

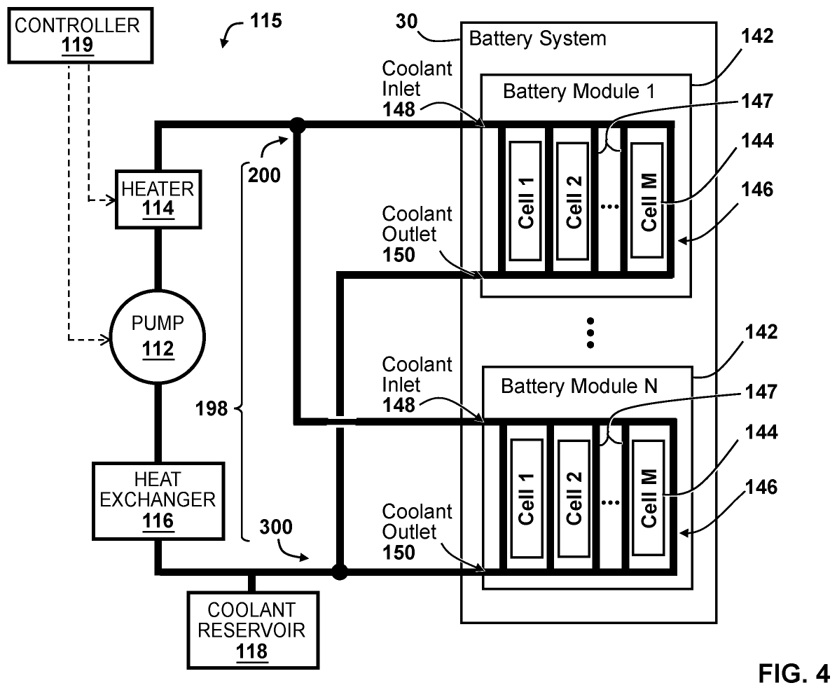

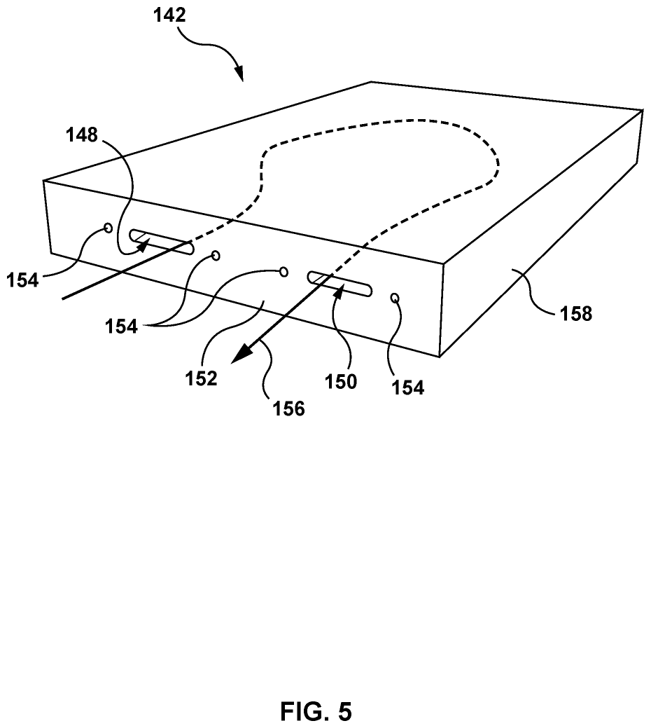

For clarity, none of the coolant inlets or coolant outlets (described below in connection with FIGS. 3 and 4) of any of the sixteen battery modules BM1-BM16 are visible in FIG. 3. The reason is that, in FIG. 3, each of the sixteen battery modules BM1-BM16 is oriented with its face 152 (see FIG. 5, described below) facing away from the viewer.

In addition to the battery modules BM1-BM16, the battery system 30 may also include other components, including but not limited to a battery charger, a battery management controller and thermal management components, for example.

FIG. 4 is a simplified schematic diagram of the thermal management system 115 and battery system 30. FIG. 4 illustrates the logical (hierarchical) structure of battery system 30. The battery system 30 includes N battery modules 142, wherein N is a positive integer greater than one. Each battery module 142 may be a discrete component of the battery system 30 that contributes to the capacity of the battery system 30. Battery modules may be added and/or removed to adjust the voltage and/or capacity of the battery system 30 as desired.

Each battery module 142 includes M battery cells 144, where M is a positive integer greater than one that may be equal to or different from N. The battery cells 144 may be pouch cells, cylindrical cells and/or prismatic cells, for example. Each battery module 142 further includes a cooling structure 146 to channel a liquid coolant (e.g., water and/or ethylene glycol) through the battery module proximate to at least some of the battery cells 144 of the battery module 142, to thermally regulate a temperature of the battery cells 144. The battery cells 144 and cooling structure 146 of the battery module 142 may be housed within a casing or other enclosure to retain and/or protect the battery cells and cooling structure.

The cooling structure 146 may for example comprise one or more cooling panels 147 as described in WIPO Patent Publication No. WO/2021/087619 entitled BATTERY COOLING PANEL FOR ELECTRIC VEHICLES and/or in U.S. patent application Ser. No. 17/091,777 entitled BATTERY COOLING PANEL FOR ELECTRIC VEHICLES, each of which is hereby incorporated by reference herein. The cooling panels 147 may be interleaved with battery cells 144, which may for example be generally flat pouch lithium-ion battery cells.

It should be appreciated that the terms “cooling structure” and “cooling panel” in this disclosure do not necessarily connote a strict cooling functionality. In some electric vehicle usage scenarios, the cooling structure 146 may also or instead be used to heat the battery cells 144. For example, for electric vehicles intended for use in a cold climate, such as the snowmobile electric vehicle 10 of FIG. 1, the cooling structure 146 may, at least initially upon electric vehicle power-up, be used to flow heated liquid coolant proximately to the battery cells 144. This may be done with a view to warming the battery cells 144 to at least a threshold minimum temperature, below which battery efficiency may be undesirably poor. In this way, the coolant described herein may more generally be referred to as a heat transfer fluid.

Referring again to FIG. 4, each battery module 142 has a coolant inlet 148 and a coolant outlet 150. The coolant inlet 148 and coolant outlet 150 serve as ingress and egress points for the liquid coolant into and out of, respectively, the cooling structure 146 of the battery module 142. As shown, the coolant inlet 148 supplies the liquid coolant to the cooling panels 147 of each battery module 142 in parallel.

A simplified representation of the physical structure of an example battery module 142 is depicted in FIG. 5 in perspective view. The physical structure of each of the battery modules depicted in FIG. 3 is substantially consistent with what is shown in FIG. 5. As illustrated, the battery module 142 has a generally cuboid shape. In the depicted embodiment, the coolant inlet 148 and the coolant outlet 150 are both located on the same face 152 of the battery module 142. This is not necessarily true in alternative battery module embodiments.

The coolant inlet 148 and the coolant outlet 150 are fluidically interconnected by the cooling structure 146 (not visible in FIG. 5) within battery module 142. Liquid coolant is flowable into coolant inlet 148, through cooling structure 146, and out of coolant outlet 150, as denoted schematically by arrow 156. It should be noted that the arrow 156 is provided by way of example, and in general the cooling structure 146 may have multiple flow paths (e.g., as defined by multiple cooling panels 147) fluidly connecting the inlet 148 to the coolant outlet 150.

In the present embodiment, each of the coolant inlet 148 and the coolant outlet 150 has an elongated obround shape. This shape may for example be chosen for compatibility with the shape of inlet and outlet channels of the cooling structure 146 disposed internally within the battery module 142 (not illustrated). Alternative battery module embodiments may have differently shaped coolant inlets and/or coolant outlets. In the depicted embodiment, a pair of threaded bores 154 flanks each of the inlet 148 and outlet 150. These pairs of threaded bores 154 facilitate attachment of respective manifold fittings, as will be described.

The thermal management system 115 (FIG. 4) of electric vehicle 10 may include, among other components: a pump 112 for circulating liquid coolant in a closed loop to and from the battery modules 142 of battery system 30; at least one coolant inlet manifold 200 (being part of the closed loop) for supplying liquid coolant to the N battery modules 142; at least one coolant outlet manifold 300 (also being part of the closed loop) for channeling liquid coolant from the N battery modules 142; a heater 114 and a heat exchanger 116 for selectively heating or cooling, respectively, the liquid coolant, some of which may at least partially fill a coolant reservoir 118; temperature sensors (not depicted) for detecting the temperature at various points within the battery system; and a controller 119 for controlling thermal management system operation based on detected conditions. The coolant inlet manifold 200 and coolant outlet manifold 300 of battery module row R3 are described below. Further details regarding an example thermal management system for an electric vehicle are provided in U.S. patent application Ser. No. 17/091,625 entitled THERMAL MANAGEMENT SYSTEM FOR ELECTRIC VEHICLE, which is hereby incorporated by reference herein.

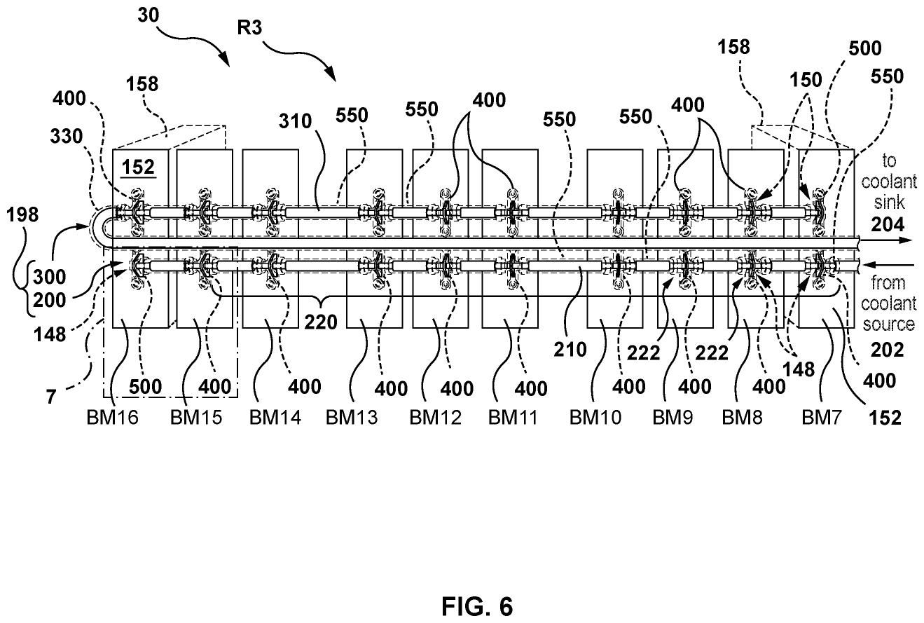

FIG. 6 is a perspective view of a coolant inlet manifold 200 for supplying liquid coolant from a coolant source 202 to the ten battery modules BM7-BM16 of battery module row R3. FIG. 6 also depicts, in perspective view, a coolant outlet manifold 300 for returning liquid coolant from the ten battery modules BM7-BM16 to a coolant sink 204. Collectively, the coolant inlet manifold 200 and coolant outlet manifold 300 may be referred to as a coolant manifold system 198. The coolant source 202 and coolant sink 204 may for example be the outlet of heater 114 and the inlet of heat exchanger 116, respectively (see FIG. 4). However, in other embodiments, different components of the closed loop thermal management system 115 (e.g., the pump 112 or the coolant reservoir 118) may serve as the coolant source 202 or the coolant sink 204. In some embodiments, an open-loop thermal management system may be used in an electric vehicle, where a body of water such as a lake may serve as the coolant source.

In FIG. 6, each of the coolant inlet manifold 200 and coolant outlet manifold 300 is depicted using a ghosting technique (dashed lines) to reveal the passages 210 and 310, respectively, defined thereby. The passages 210 and 310 are depicted in FIG. 6 as positive representations of hollow spaces. In other words, the shape of the passages 210, 310 in FIG. 6 represents the shape that liquid coolant flowing through the coolant inlet manifold 200 and coolant outlet manifold 300, respectively, would assume if the manifolds 200, 300 were transparent.

In FIG. 6, the battery modules BM7-BM16 are depicted in simplified form, with only their faces 152 visible. To provide a sense of the perspective with which the coolant inlet manifold 200 and coolant outlet manifold 300 are illustrated, the perspective outline of each of the first and tenth battery modules BM7 and BM16 is depicted in dashed lines.

As shown in FIG. 6, the ten battery modules BM7-BM16 are arranged in a row or stack. Each of the battery modules BM7-BM16 is oriented vertically, with face 158 (see FIG. 5) facing upwardly. As a result, the coolant inlets 148 of the ten battery modules BM7-BM16 are aligned horizontally in FIG. 6. Similarly, the coolant outlets 150 of the ten battery modules BM7-BM16 are also aligned horizontally in FIG. 6, above the coolant inlets 148.

The coolant inlet manifold 200 supplies coolant from the coolant source 202 to each of the coolant inlets 148 of the ten battery modules BM7-BM16 in parallel. In other words, the coolant fluid received by the coolant inlet manifold 200 from the coolant source 202 is split between the cooling structures 146 of each of the battery modules BM7-BM16. The coolant inlet manifold 200 includes a substantially straight supply conduit 220 and ten branch conduits 222—one for each of battery modules BM7-BM16. In the illustrated example, the supply conduit 220 extends horizontally along battery module row R3, from upstream of the upstream-most battery module BM7 to the second-to-downstream-most battery module BM15. In this context, the terms “upstream” and “downstream” are relative to a general direction of coolant flow through the supply conduit 220 (right to left in FIG. 6). Each of the branch conduits 222 is fluidically coupled to the coolant inlet 148 of a respective one of the battery modules BM7-BM16.

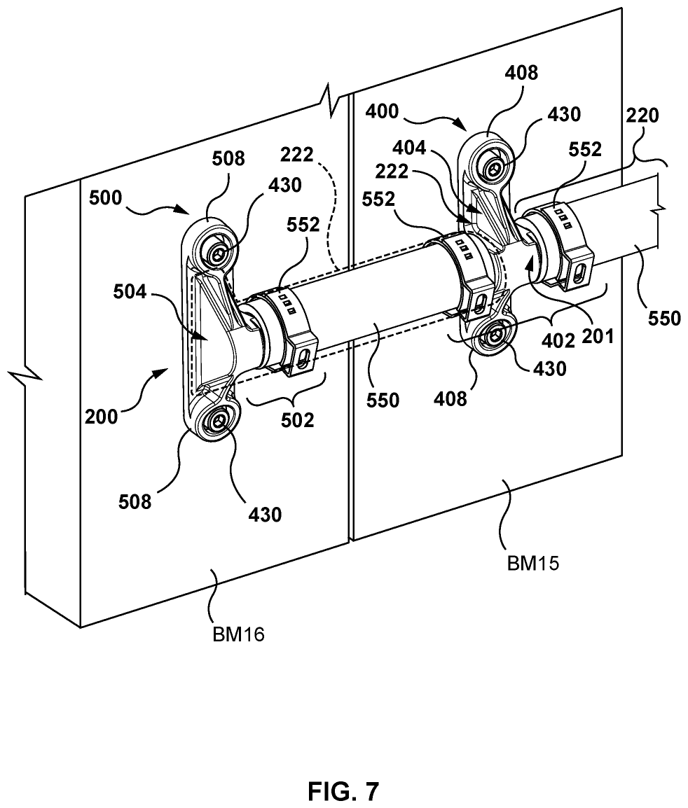

FIG. 7 is an isometric close-up view of a portion of the coolant inlet manifold 200 of FIG. 6. FIG. 7 provides a more detailed view of modular components from which the coolant inlet manifold 200 of the present embodiment is constructed. The modular components include a through fitting 400, an end fitting 500, and conduit sections 550 (e.g., sections of hose). The through fitting 400 and end fitting 500 may be referred to generically or collectively as manifold fittings.

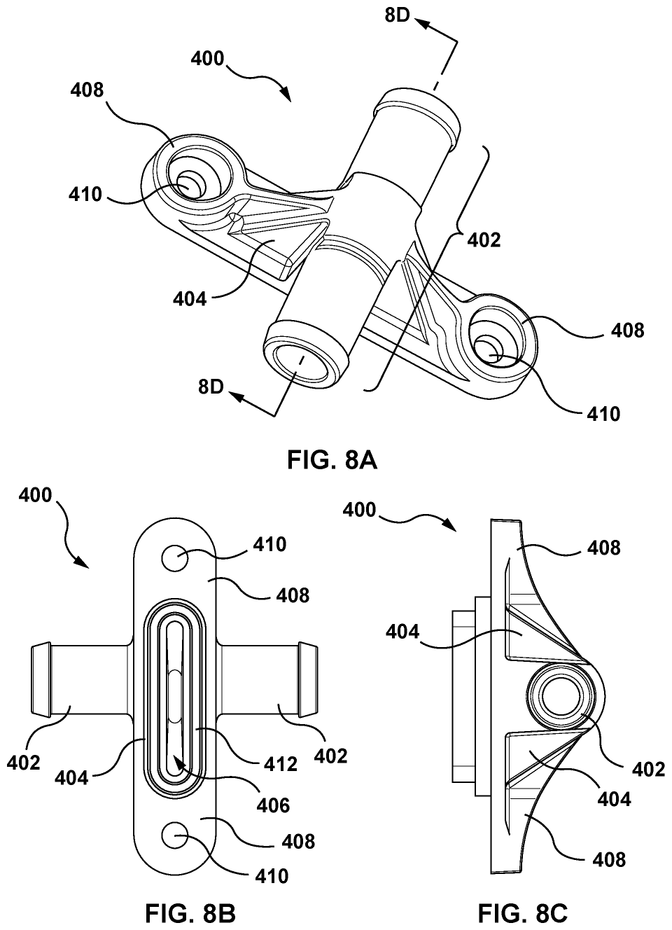

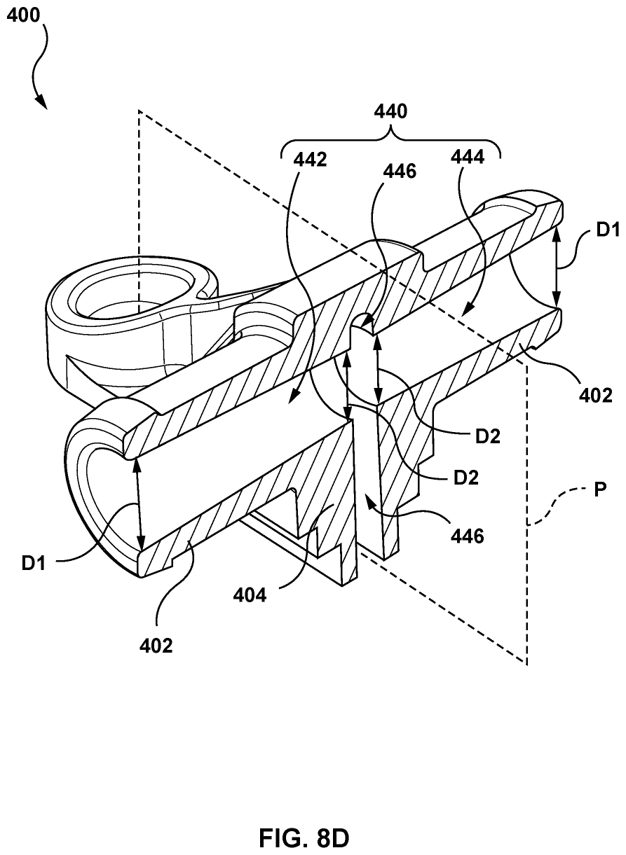

FIG. 8A-8C depict the through fitting 400 in isometric top view, bottom view, and side view, respectively. The through fitting 400 may be a form of tee junction having a straight run portion 402 and a branch portion 404.

The run portion 402 may be the main conduit, i.e., the “crossbar of the T” of the tee junction. The run portion 402 is straight and open at both ends. In the present embodiment, the run portion 402 is substantially cylindrical and is barbed at each end to promote retention of conduit sections 550 (FIG. 7), which are pliable in the present embodiment.

The branch portion 404 of the manifold fitting 400 (FIG. 8A-8C) extends orthogonally from the run portion 402 and is fluidically connected therewith. In the present embodiment, the branch portion 404 has a flattened cone shape and widens distally. The distal end of branch portion 404 has an obround opening 406 (FIG. 8B) and is sized to fit into the obround coolant inlet 148 of the battery module 142 to form a fluidic connection therewith. The distal end of branch portion 404 also fits into the coolant outlet 150 of battery module 142. In alternative embodiments, the angle between the branch portion of the through fitting and the run portion of the through fitting may vary, i.e., is not necessarily 90 degrees.

The through fitting 400 additionally has a pair of integral brackets 408 on either side of, and in line with, the obround opening 406. Each of the brackets 408 has a respective through hole 410. The pair of through holes 410 is spaced apart from one another by the same distance as the pair of threaded bores 154 flanking coolant inlet 148 of battery module 142 (FIG. 5), for alignment therewith. A gasket 412 (FIG. 8B) about the distal end of the branch portion 404 facilitates establishment of a liquid-tight seal when the through fitting 400 is attached to the coolant inlet 148.

FIG. 8D is a cross-section of the through fitting 400 taken along line 8D-8D of FIG. 8A. The run portion 402 of the through fitting 400 defines a passage 440 having two passage halves 442 and 444, each on a respective side of a branch passage 446 defined by the branch portion 404. In this embodiment, the through fitting 400 is bilaterally symmetric with respect to plane P. Therefore, each passage half 442, 444 is a mirror image of the other passage half 444, 442. Such bilateral symmetry is not necessarily required in all embodiments. In this embodiment, each passage half 442, 444 is frustoconical, tapering inwardly from a first diameter D1 to a second, lesser diameter D2. When the through fitting 400 is injection molded from plastic, the tapering may facilitate removal from a mold and minimizing a risk of damage the surfaces of the molded part during manufacture. Tapering is not necessarily present in alternative through fitting embodiments. The branch passage 446 has a flattened cone shape, which is shown edge-on in FIG. 8D.

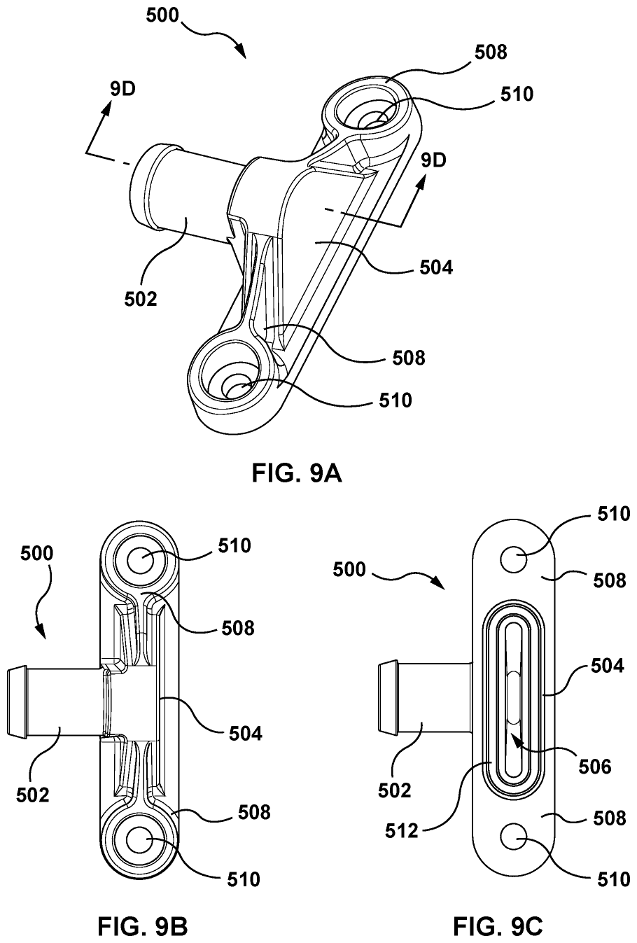

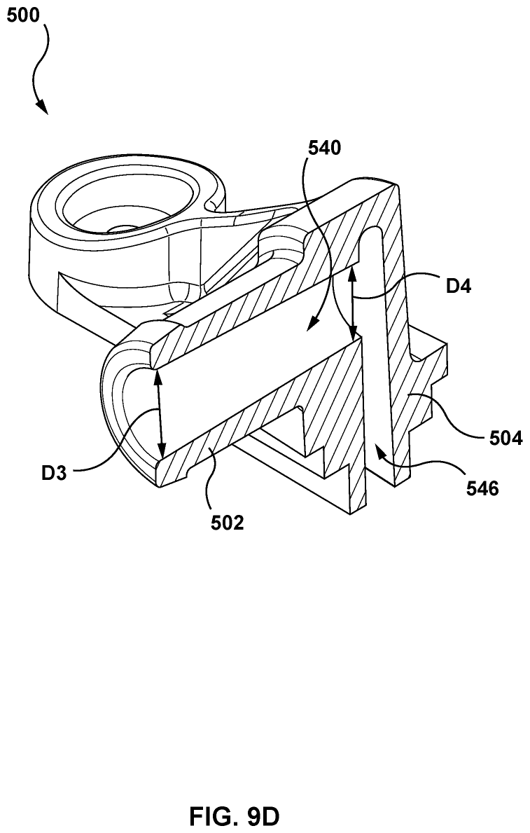

FIG. 9A-9C depict the end fitting 500 of FIG. 7 in top perspective view, top view, and bottom view, respectively. In the present embodiment, the fitting 500 is a 90-degree elbow fitting having two tubular portions 502 and 504 joined at a right angle. The angle between the first tubular portion and second tubular portion may vary, i.e., is not necessarily 90 degrees, in other elbow fitting embodiments.

The first tubular portion 502 is a substantially cylindrical tube with a barbed end. The barbed end serves a similar purpose as the barbed ends of run portion 402 of through fitting 400 of FIGS. 8A-8D.

The second tubular portion 504 of the end fitting 500 extends at an angle from the first portion 502 (90 degrees in this embodiment) and is fluidically connected therewith. The shape of the second tubular portion 504 of end fitting 500 is similar to that of the branch portion 404 of fitting 400 (described above), i.e., a flattened cone shape that widens distally. The distal end of the second tubular portion 504 has an obround opening 506 and is sized to fit into the obround coolant inlet 148, as well as the obround coolant outlet 150, of the battery module 142.

Like through fitting 400, the end fitting 500 has a pair of integral brackets 508. The brackets 508 of fitting 500 are situated on either side of, and in line with, the obround opening 506. Each of the brackets 508 has a respective through hole 510. The through holes 510 serves a similar purpose to the through holes 410 of through fitting 400. A gasket 512 (FIG. 9C) about the distal end of the second tubular portion 504 facilitates establishment of a liquid-tight seal when the end fitting 500 is attached to a coolant inlet 148 of a battery module 142.

FIG. 9D is a cross-section of the end fitting 500 taken along line 9D-9D of FIG. 9A. The tubular portion 502 defines a frustoconical passage 540 that tapers inwardly from a first diameter D3 to a second, lesser diameter D4. The extent of diameters D3 and D4 of FIG. 9D may be the same as, or different from, that of diameters D1 and D2, respectively, of FIG. 8D. The rationale for the taper may be the same as for the taper of passage halves 442, 444 of through fitting 400. Alternative embodiments of passage 540 may be untapered. The second tubular portion 504 of the end fitting 500 defines a passage 546 having a flattened cone shape, which is shown edge-on in FIG. 9D.

Referring again to FIG. 7, modular components 400, 500, and 550 are interconnected as follows. A first conduit section 550 fluidically connects the first tubular portion 502 of end fitting 500 with one end of run portion 402 of the through fitting 400. A second conduit section 550, which is only partly shown in FIG. 7, is fluidically connected with the other end of run portion 402 of through fitting 400. The connections are secured using hose clamps 552 in the present embodiment. The conduit section 550 that is upstream of through fitting 400 defines a downstream-most portion of the supply conduit 220 of the coolant inlet manifold 200 (FIG. 6), which is substantially straight and has a downstream end 201 just upstream of branch portion 404 of through fitting 400.

The branch portions 404 of the nine through fitting 400 constitute the nine upstream-most branch conduit 222 of the coolant inlet manifold 200 (FIG. 6). As shown in FIG. 7, a tenth branch conduit 222 of coolant inlet manifold 200 is collectively defined by the following components: a part of the run portion 402 of through fitting 400, associated with battery module BM15, that is downstream of branch portion 404; the conduit section 550 that interconnects through fitting 400 and end fitting 500; and the end fitting 500, including first tubular portion 502 and second tubular portion 504. The latter branch conduit 222, which is at the downstream end 201 of the coolant supply conduit 220, may be referred to as the downstream-most or terminal branch conduit because it is furthest downstream along the supply conduit 220, e.g., relative to the coolant source 202. It will be appreciated that the terminal branch conduit 222 of the present embodiment incorporates the entirety of end fitting 500, which is an elbow fitting in the present embodiment. As such, the terminal branch conduit 222 has a different shape from all of the other branch conduits 222 of coolant inlet manifold 200, each of which is defined primarily or solely by the branch portion 404 of a respective through fitting 400. In alternative embodiments, it is not necessarily required for terminal branch conduits to have a different shape from other branch conduits of the coolant inlet manifold. In some embodiments, the “branch” portion 504 of the end fitting 500 may be considered as the terminal branch conduit 222. In such embodiments, the tubular portion 502 of the end fitting 500 may be considered to define the downstream end of the supply conduit 220.

Distal ends of the branch portion 404 of the through fitting 400 and of the second tubular portion 504 of end fitting 500 are fluidically coupled to the coolant inlets 148 of battery modules BM15 and BM16 respectively. In the present embodiment, the fluidic coupling of the through fitting 400 with the coolant inlet 148 of battery module BM15 is secured by a pair of threaded fasteners 430. The two fasteners 430 pass through the holes 410 (see FIG. 8A-8C) of the pair of brackets 408 and are received in the two threaded bores 154 (FIG. 5), respectively, that flank the coolant inlet 148 of battery module BM15. The end fitting 500 is similarly fastened to the coolant inlet 148 of battery module BM16.

The remainder of the supply conduit 220, which is not shown in FIG. 7 but is visible in FIG. 6, is similarly constructed from conduit sections 550 and through fittings 400. In total, the coolant inlet manifold 200 of FIG. 6 comprises nine through fittings 400 (one for each of battery modules BM7-BM15), one end fitting 500 (for battery module BM16), and ten conduit sections 550. The nine branch portions 404 of the nine through fittings 400, and the sole end fitting 500 together with the conduit section 550 connected thereto, collectively constitute ten branch conduits 222 of the supply conduit 220. Each of the branch conduits 222 branches from the supply conduit 220 to a respective one of the ten battery modules BM7-BM16 and is fluidically coupled to the coolant inlet 148 of its respective battery module. For clarity, “branching” of a conduit in this context includes “forking”, in the sense that a branch conduit provides one of at least two distinct flow channels from a branch point with a superordinate conduit (e.g., be it one of multiple subordinate conduits at an end of the superordinate conduit or a single subordinate conduit splitting away from the superordinate conduit with the superordinate conduit continuing beyond the split).

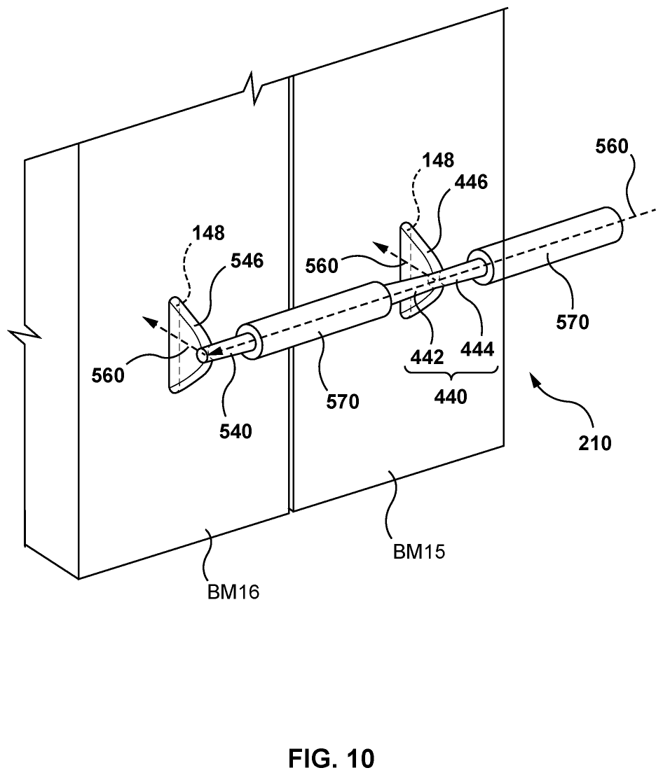

FIG. 10 is a close-up isometric view of a portion of the passage 210—i.e., a positive representation of hollow space—defined by the portion of coolant inlet manifold 200 depicted in FIG. 7. The arrows 560 show the direction of liquid coolant flow. From the upstream direction, liquid coolant flows through the first cylindrical passage 570, which is defined by one of the conduit sections 550 (FIG. 7). From there, coolant flows into the first half 444 of the passage 440 defined by the run portion 402 of through fitting 400 (FIG. 8D). Within the through fitting 400, the liquid coolant splits into two streams. A first coolant stream flows orthogonally through a first branch conduit 222, i.e., branch passage 446, into the coolant inlet 148 of battery module BM15. A second coolant stream continues flowing straight into a second branch conduit 222, i.e., through the second passage half 442 and into another cylindrical passage 570 formed by the second conduit section 550. From there, the liquid coolant flows through the remainder of the branch conduit 222, i.e., through passage 540 and then orthogonally through branch passage 546 into the coolant inlet 148 of battery module BM16.

As shown in FIG. 10, the cross-sectional area of each of cylindrical passages 570 taken transversely to the general direction of liquid flow is larger than the cross-sectional area of either of passage 440 of through fitting 400 or passage 540 of end fitting 500. This relative sizing may minimize an overall pressure drop of liquid coolant flowing through the passage 210 defined by the coolant inlet manifold 200 (FIG. 6).

Referring again to FIG. 6, the coolant outlet manifold 300 fluidically couples each of the coolant outlets 150 of the battery modules BM7-BM16 with the coolant sink 204. The coolant outlet manifold 300 is constructed from many of the same modular components described above, including through fittings 400, an end fitting 500, and conduit sections 550. By virtue of the 180-degree U-bend 330, the upstream-most battery module BM7 along the coolant inlet manifold 200 is the downstream-most battery module BM7 along the coolant outlet manifold 300. Conversely, the downstream-most battery module BM16 along the coolant inlet manifold 200 is the upstream-most battery module BM16 along the coolant outlet manifold 300. This arrangement tends to promote a more uniform coolant flow across the ten battery modules BM7-BM16.

In the example shown in FIG. 6, the same type of through fitting 400 is used to define the branch conduit 222 supplying each respective one of the battery modules BM7-BM15. Further, end fitting 500 is used to define (at least in part) the branch conduit 222 supplying the downstream-most battery module BM16. Moreover, the branch passage 546 of the end fitting 500 may be similarly shaped to the branch passages 446 of the through fittings 400. As such, the size and the shape of each the nine branch conduits 222 supplying battery modules BM7 to BM15 along the supply conduit 220 may be substantially identical to the shape of the distal end of the branch conduit supplying battery module BM16. In this way, the through fittings 400 and end fitting 500 in FIG. 7 collectively might not preferentially direct coolant fluid to any subset of the battery modules BM7-BM16.

The rate of coolant fluid flow through different ones of the ten branch conduits 222 may be affected by at least two factors. A first factor is fluid pressure at the branch point from the supply conduit 210. In general, a higher coolant fluid pressure at the branch point of a branch conduit 222 may result in a greater rate of coolant flow through the branch conduit 222. Due to friction, the coolant fluid may experience a pressure drop along the supply conduit 210 with increased distance from the coolant source 202. As a result, and absent other factors, the coolant flow rate through the upstream-most branch conduits 222 may generally be greater than the coolant flow rate through one or more branch conduits 222 further downstream along supply conduit 210.

A second factor that may affect a rate of coolant fluid flow through different ones of the branch conduits 222 is inertia, i.e., a momentum of the coolant fluid flow through the supply conduit 210. At all branch conduits 222 but the downstream-most one associated with battery module BM16, inertia may disproportionately favor fluid flow through the straight passage 440 (FIG. 8D) of through fitting 400, which is in-line with the substantially straight supply conduit 210, over fluid flow into the branch passage 446, which is orthogonal to the supply conduit 210. The flow rate of coolant into the branch passage 546 defined by the tubular portion 504 of end fitting 500 supplying battery module BM16 may be relatively high. The reason is that the branch passage 546 will be the sole egress passage for coolant carried by inertia into the downstream-most branch passage 222.

Due to these factors, the battery module(s) connected at or near a downstream end of the coolant inlet manifold 200 (e.g., battery modules BM16, BM15) may receive significantly more coolant flow than battery modules connected closer to the upstream end of the inlet manifold (e.g., battery modules BM8-BM14). Moreover, the battery module BM7 connected closest to the upstream end of the coolant inlet manifold 200 may receive more coolant flow than the battery modules disposed more centrally along battery module row R3 (e.g., battery modules BM8-BM14).

Uneven distribution of coolant flow between the cooling structures of the battery modules BM7-BM16 in FIG. 6 may cause the cooling and/or heating rates for the battery modules BM7-BM16 to be non-uniform. By way of example, the cooling rate for battery module BM16 might be ten times greater than the cooling rate at one or more of the other battery modules BM7-BM15 in some implementations. Similar discrepancies may exist in the heating rates as between battery modules BM7-BM16, although these will not necessarily be identical to the cooling rate discrepancies, e.g., due to differences in a cooling rate of the heat exchanger 116 versus the heating rate of heater 114 (see FIG. 4).

The discrepancies in cooling rates and heating rates for the battery modules BM7-BM16 in FIG. 6 reflect the possibility of a least a transient discrepancy in battery module temperature as between different ones of the ten battery modules BM7-BM16 during operation of electric vehicle 10. Such temperature discrepancies may disadvantageously reduce the efficiency of the thermal management system 115. For example, it may be necessary to expend additional power running the pump 112 to circulate more coolant fluid in order to properly heat/cool any batteries that are receiving less coolant fluid flow. Temperature discrepancies could also lead to critical over/under heating of certain battery modules (e.g., battery modules that are more centrally disposed along the supply conduit 210, such as battery modules BM8-BM14) during use of the electric vehicle 10.

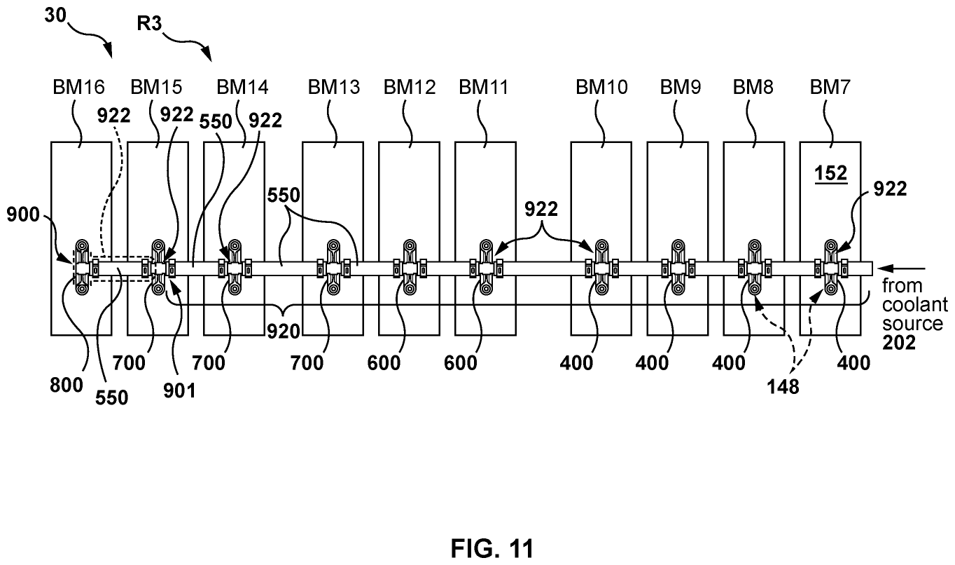

FIG. 11 is an isometric view of an alternative coolant inlet manifold 900 for supplying liquid coolant from coolant source 202 to the ten battery modules BM7-BM16 of battery module row R3. The coolant inlet manifold 900 is configured to promote more uniform heating rates and/or cooling rates in the battery modules BM7-BM16 during operation of the electric vehicle 10 compared to that of the coolant inlet manifold 200. To that end, flow restrictors are introduced at select locations of the coolant inlet manifold 900, as described below. Other aspects of the thermal management system 115, e.g., as described above, may remain unchanged.

The notation and conventions of FIG. 11 are generally similar to those of FIG. 6. A distinction from FIG. 6 is that the inner passages defined by the coolant inlet manifold 900 are not visible in FIG. 11. Another distinction from FIG. 6 is that, for brevity, coolant outlet manifold 300 is omitted. However, the same coolant outlet manifold 300 as is shown in FIG. 6 could be used.

The coolant inlet manifold 900 fluidically couples the coolant source 202 with each of the coolant inlets 148 of the battery modules BM7-BM16 for supplying coolant in parallel to the ten battery modules. Like coolant inlet manifold 200, the coolant inlet manifold 900 includes a substantially straight supply conduit 920, oriented horizontally in FIG. 11, and ten branch conduits 922, one for each of battery modules BM7-BM16. Like the nine upstream-most branch conduits 222 of FIG. 6, the nine upstream-most branch conduits 922 of FIG. 11 are each substantially orthogonal to the supply conduit 920. The downstream-most branch conduit 922, which is at a downstream end 901 of the coolant supply conduit 920, is collectively defined by the downstream half of the run portion 402 of the through fitting 400 associated with battery module BM15, an end fitting 800 (described below), and an interconnecting conduit section 550. Each of the branch conduits 922 is fluidically coupled to the coolant inlet 148 of a respective one of the battery modules BM7-BM16.

Like the coolant inlet manifold 200, the coolant inlet manifold 900 of the present embodiment is constructed from modular components: ten conduit sections, nine through fittings, and one end fitting. Some of the modular components used to construct coolant inlet manifold 900 may be identical to the modular components used to construct coolant inlet manifold 200. These include all of the conduit sections 550 and the through fittings 400 associated with each of the four upstream-most battery modules BM7-BM10 respectively.

However, five of the through fittings comprising coolant inlet manifold 900 differ from those of coolant inlet manifold 200, as follows: the two through fittings 400 associated with battery modules BM11 and BM12 respectively are each replaced with a first restricted through fitting 600, and the three through fittings 400 associated with battery modules BM13, BM14, and BM15 respectively are each replaced with a second restricted through fitting 700. Moreover, the end fitting 500 of coolant inlet manifold 200 is replaced with a restricted end fitting 800 in coolant inlet manifold 900.

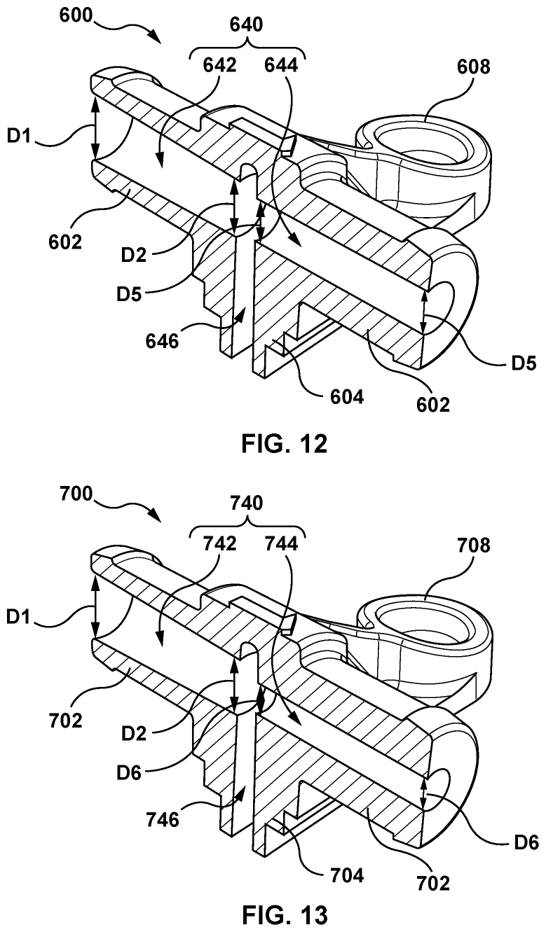

FIG. 12 depicts the first restricted through fitting 600 in cross-section. The restricted through fitting 600 is in certain respects identical to the unrestricted through fitting 400 of FIGS. 7A-7D. For example, the following features of through fitting 600 are analogous or identical to the corresponding features of through fitting 400 having same reference number less 200: run portion 602; branch portion 604; bracket 608; passage half 642; and branch passage 646. Like passage half 442 of through fitting 400 (FIG. 8D), the passage half 642 of restricted through fitting 600 is frustoconical and inwardly tapered, from a larger upstream diameter D1 to a smaller downstream diameter D2, for similar reasons as for through fitting 400. The direction of liquid coolant flow through the run portion 602 is left to right in FIG. 12.

The primary difference between restricted through fitting 600 and unrestricted through fitting 400 is that the passage half 644 of the former is constricted compared to the upstream passage half 642. The part of run portion 602 of through fitting 600 immediately downstream of the orthogonal branch passage 646 defines a constriction that effectively constitutes a built-in flow restrictor. The flow restrictor is configured to restrict a flow of liquid coolant relative to an extent of liquid coolant flow just upstream of the branch passage 646. In the present embodiment, the constricted passage half 644 is cylindrical and has a narrower diameter D5 than the diameter D2 of passage half 642 immediately upstream of branch passage 646 (which may be referred to as unconstricted passage half 642). In one example, D5 is two-thirds the size of D2. In that example, the transverse (circular) cross sectional area of the downstream passage half 644 is less than half of the cross-sectional area of the downstream end of the upstream passage half 642. Other ratios of D5 to D2 are also contemplated. In alternative embodiments, passage half 644 could be frustoconical (tapered) rather than cylindrical. It will be appreciated that the upstream, unconstricted passage half 642 and the downstream, constricted passage half 644 defined by respective parts of the same run portion 602 of through fitting 600 are not mirror images of one another like passage halves 442, 444 of through fitting 400.

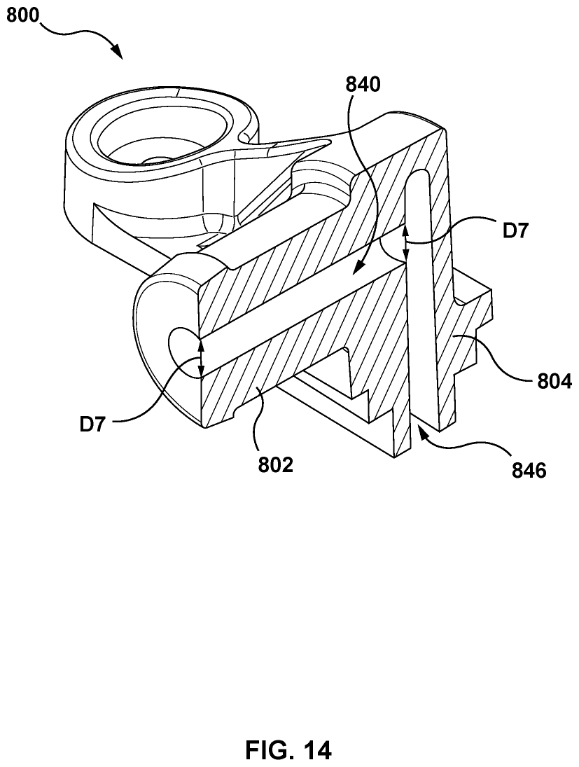

FIG. 13 depicts the second restricted through fitting 700 in cross-section. Through fitting 700 is in many respects identical to the through fitting 600 of FIG. 12. An exception is that the built-in flow restrictor of the through fitting 700, i.e., constricted passage half 744, is even narrower than the passage half 644 of through fitting 600. That is, constricted passage half 744, which is cylindrical in the present embodiment, has a diameter D6 that is smaller than diameter D5 of passage half 644 of FIG. 12. In one example, D6 is approximately 58% the size of D2 of the immediately upstream end of passage half 742 of through fitting 700 (which may be referred to as unconstricted passage half 742) Other ratios of D6 to D5 are also contemplated. Other features of through fitting 700, including branch portion 704, passage half 742, branch passage 746, and bracket 708, are analogous or identical to the corresponding features of through fitting 600 having same reference numbers less 100.

FIG. 14 depicts the restricted end fitting 800 in cross-section. Restricted end fitting 800 is an elbow fitting that is in many respects identical to the end fitting 500 of FIGS. 8A-8D. An exception is that the tubular portion 802 effectively defines a built-in flow restrictor configured to restrict coolant flow into the branch portion 804. In other words, the inner diameter of the cylindrical tubular portion 802 upstream of the tubular portion 804 is narrower that the inner diameter of the corresponding tubular portion 502 of unrestricted end fitting 500 of FIGS. 8A-8D. In the present embodiment, the diameter D7 of constricted passage 840 in the cylindrical tubular portion 802 of the restricted end fitting 800 is the same as the diameter D6 of the constricted passage half 744 of the second restricted through fitting 700. Other features of end fitting 800, including branch portion 804, branch passage 846, and bracket 808, are analogous or identical to the corresponding features of end fitting 500 having same reference numbers less 300.

FIGS. 12-14 illustrate examples of flow restrictors implemented in the tubular portions of through fittings and end fittings, but other examples are also contemplated. In some embodiments, flow restrictors may be implemented in the branch portions 604, 704, 804 to restrict the flow through the branch passages 646, 746, 846 associated with certain battery modules. This may restrict the flow to downstream battery modules, for example. In some embodiments, flow restrictors may also or instead be implemented in the conduit sections 550 and/or in the battery modules BM7-BM16 themselves.

Referring again to FIG. 11, it will now be appreciated that the substantially straight coolant supply conduit 920 of coolant inlet manifold 900 is collectively defined by the following eighteen components: four run portions 402 of the four respective through fittings 400 associated with battery modules BM7-BM10; two run portions 602 of the two respective restricted through fittings 600 associated with battery modules BM11 and BM12; two run portions 702 of the two respective restricted through fittings 700 associated with battery modules BM13 and BM14; an upstream part (upstream of branch passage 704) of the run portion 702 of the restricted through fitting 700 associated with battery module BM15; and nine conduit sections 550 interleaved with the various manifold fittings 400, 600, and 700 listed above. As was the case for supply conduit 220 of coolant inlet manifold 200, the inner diameter of the conduit sections 550 comprising the supply conduit 920 of coolant inlet manifold 900 is larger than the inner diameter of the run portions of any of the manifold fittings of the coolant inlet manifold 900.

In view of this structure, for each of a downstream-most subset of the ten battery modules comprising battery module row R3 excluding the last battery module BM16—specifically, battery modules BM11-BM15 in this example—the coolant inlet manifold 900 includes an associated flow restrictor disposed along the coolant supply conduit 920 immediately downstream of the branch conduit 922 supplying coolant to that battery module. In the case of battery modules BM11 and BM12, the flow restrictor is the constricted passage 644 defined by restricted through fitting 600 (FIG. 12). In the case of battery modules BM13-BM15, the flow restrictor is the constricted passage 744 defined by restricted through fitting 700 (FIG. 13). It will be appreciated that the extent to which each of the six flow restrictors of the coolant inlet manifold 900 (including the flow restrictor effectively defined by constricted passage 840 of restricted end fitting 800, described below) restricts a flow of liquid coolant increases monotonically in the downstream direction along the supply conduit 920. In a sense, the upstream walls or edges of the constricted passage 644 of restricted through fitting 600 facing the branch passage 646 act to deflect or otherwise direct some coolant fluid flowing through the run portion 602 into the branch portion 604. Similar comments apply to the constricted passage 744 of restricted through fitting 700.

The end fitting 800 associated with the downstream-most battery module BM16 also defines an associated flow restrictor, i.e., the constricted passage 840. However, unlike the flow restrictors associated with battery modules BM11-BM15, the flow restrictor of end fitting 800 is disposed within—not downstream of—the branch conduit 922 supplying coolant to the associated battery module BM16, specifically in the tubular portion 802 of the elbow fitting 800. In this embodiment, the flow restrictor associated with the downstream-most battery module BM16 (constricted tubular passage 840) is configured to restrict a flow of liquid coolant through the downstream-most branch conduit 922 to at least the same extent as the nearest upstream flow restrictor (constricted passage half 744 of the through fitting 700 associated with battery module BM15).

The through fittings 600, 700 and end fitting 800 of coolant inlet manifold 900 define a plurality of flow restrictors. Each flow restrictor may restrict coolant flow to a respective subset of the branch conduits 922 branching from the coolant supply conduit 920 downstream of that flow restrictor, as shown in Table 1 below.

TABLE 1
Flow Restrictor vs. Subset of Branch Conduits
to which Flow is Restricted Thereby

| | | | NUMBER OF |
|---|---|---|---|
| | | RESPECTIVE SUBSET OF | BRANCH |
| | | BRANCH CONDUITS TO WHICH | CONDUITS |
| # | FLOW RESTRICTOR | FLOW IS RESTRICTED THEREBY | IN SUBSET |
| 1. | Passage 840 of end | Branch conduit 922 supplying | 1 |
| | fitting 800 associated | battery module BM16 | |
| | with battery module | | |
| | BM16 | | |
| 2. | Passage 744 of through | Branch conduit 922 as identified in | 1 |
| | fitting 700 associated | preceding row #1 of this table | |
| | with battery module | | |
| | BM15 | | |
| 3. | Passage 744 of through | Branch conduit 922 supplying | 2 |
| | fitting 700 associated | battery module BM15 (i.e., branch | |
| | with battery module | portion 704 of through fitting 700) | |
| | BM14 | *AND* | |
| | | Branch conduit 922 as identified in | |
| | | preceding row #2 of this table | |
| 4. | Passage 744 of through | Branch conduit 922 supplying | 3 |
| | fitting 700 associated | battery module BM14 (i.e., branch | |
| | with battery module | portion 704 of through fitting 700) | |
| | BM13 | *AND* | |
| | | Branch conduits 922 as identified in | |
| | | preceding row #3 of this table | |
| 5. | Passage 644 of through | Branch conduit 922 supplying | 4 |
| | fitting 600 associated | battery module BM13 (i.e., branch | |
| | with battery module | portion 704 of through fitting 700) | |
| | BM12 | *AND* | |
| | | Branch conduits 922 as identified in | |
| | | preceding row #4 of this table | |
| 6. | Passage 644 of through | Branch conduit 922 supplying | 5 |
| | fitting 600 associated | battery module BM12 (i.e., branch | |
| | with battery module | portion 604 of through fitting 600) | |
| | BM11 | *AND* | |
| | | Branch conduits 922 as identified in | |
| | | preceding row #5 of this table | |

The coolant inlet manifold 900 may improve the uniformity of coolant fluid flow to the coolant structures of the battery modules BM7-BM16 by restricting flow to the downstream battery modules (e.g., BM15, BM16). In some implementations, using the coolant inlet manifold 900, the difference in the heating/cooling rates between the battery module receiving the most coolant fluid and the battery module receiving the least coolant fluid may be less than 5 times greater, less than three times greater, less than two times greater, or substantially negligible.

It should be noted that the number and arrangement of the through fittings 400, the restricted through fittings 600, 700 and the end fitting 800 in the coolant inlet manifold 900 are provided by way of example. Other embodiments of coolant inlet manifolds having different numbers and configurations of fittings are also contemplated. In one alternate embodiment, each of the battery modules BM7-BM15 may be coupled to a different through fitting. The degree of constriction provided by these though fittings may increase from the upstream-most battery module BM7 to the downstream battery module BM15 to produce a more uniform distribution of coolant fluid to the battery modules BM7-BM15. It should also be noted that restricted fittings may be implemented in the battery module rows R1, R2 to improve the uniformity of coolant fluid distribution to the battery modules BM1-BM6.

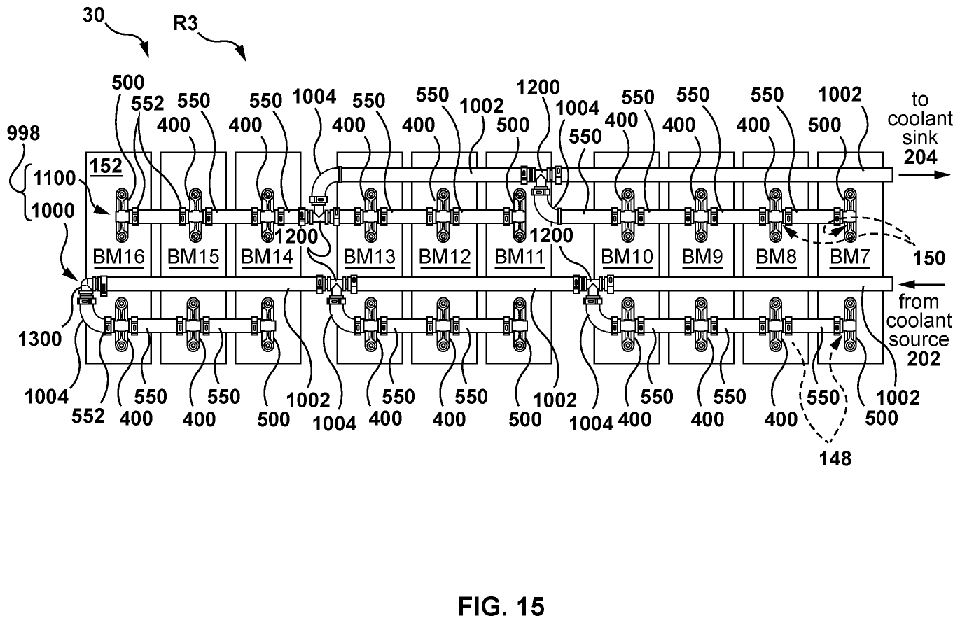

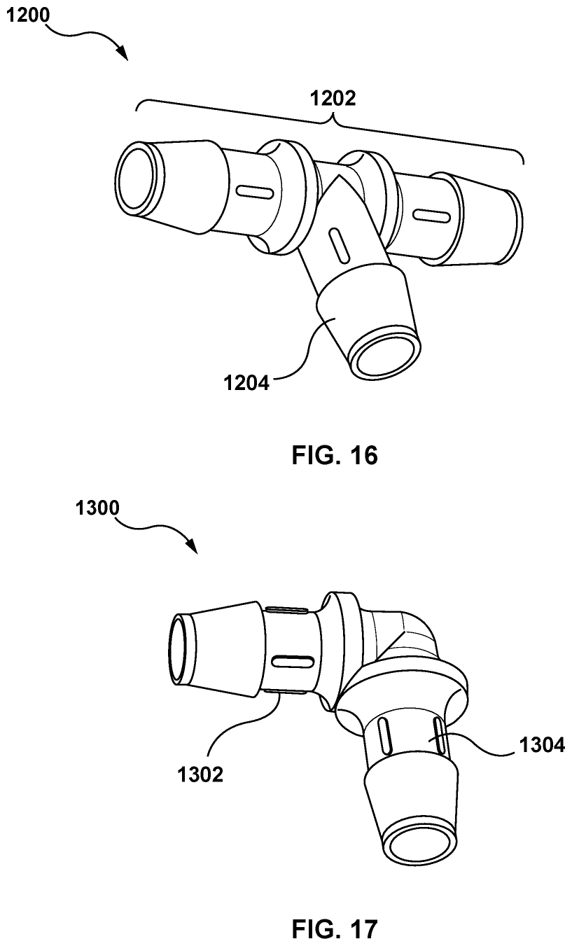

FIG. 15 is an isometric view of a further alternative coolant inlet manifold 1000 for supplying liquid coolant from coolant source 202 to the ten battery modules BM7-BM16 of battery module row R3 in parallel. The battery modules BM7-BM16 are depicted in simplified form in FIG. 15, each showing only the face 152 in which the coolant inlets 148 and coolant outlets 150 are both disposed. Also depicted in FIG. 15 is a corresponding coolant outlet manifold 1100, which collectively with coolant inlet manifold 1000 may form a coolant manifold system 998.

The coolant inlet manifold 1000 of FIG. 15 is designed to promote more uniform heating rates and/or cooling rates among the ten battery modules BM7-BM16 during operation of the electric vehicle 10 compared to the coolant inlet manifold 200 of FIG. 6. However, unlike the coolant inlet manifold 900 of FIG. 11, coolant inlet manifold 1000 might not employ flow restrictors to that end. Rather, the coolant inlet manifold 1000 utilizes a tree-like, three-level hierarchy of supply conduits, described below, to promote uniformity of battery module heating and/or cooling rates. Other aspects of the thermal management system 115 that are described above may remain unchanged.

As shown in FIG. 15, the coolant inlet manifold 1000 of the present embodiment is constructed from modular components. Some of the modular components are identical to those used to construct coolant inlet manifold 200 of FIG. 6, including conduit sections 550, through fittings 400, end fittings 500, and hose clamps 552. Other modular components, including conduit sections 1002, elbow conduit 1004, through fitting 1200, and elbow fitting 1300, are newly introduced.

Conduit sections 1002 are similar to conduit sections 550 but are longer. The transverse cross-sectional area of the passages defined by conduit sections 550 and 1002 respectively may be the same.

Elbow conduit 1004 is a curved section of conduit that bends 90 degrees. The transverse cross-sectional area of the passage defined by elbow conduit 2004 may be the same as that of the passages defined by either of conduit sections 550 and 1002.

Through fitting 1200 is depicted in FIG. 16 in isometric view. Through fitting 1200 is a tee junction having a generally cylindrical run portion 1202 and a generally cylindrical branch portion 1204 extending orthogonally from the run portion 1202. The transverse cross-sectional area of the passages defined by each of the run portion 1202 and branch portion 1204 may be the same.

Elbow fitting 1300 is depicted in FIG. 17 in isometric view. The elbow fitting has a straight, generally cylindrical, tubular portion 1302 and straight, generally cylindrical, tubular portion 1304 (which may be referred to as a branch portion 1304) extending orthogonally from the first portion 1302. The transverse cross-sectional area of the passages defined by the run portion 1302 and branch portion 1304 respectively may be the same. In the present disclosure, it is assumed that the elbow fitting 1302 is always installed so that liquid flows in the direction from portion 1302 to portion 1304.

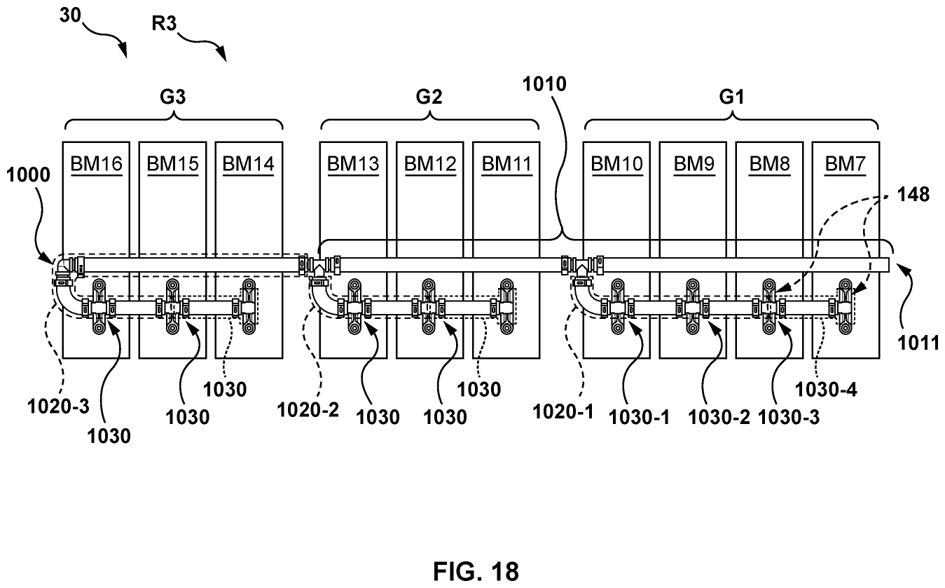

FIG. 18 is an isometric view of the coolant inlet manifold 1000 of FIG. 15 that emphasizes its hierarchical structure. In FIG. 18, only the respective faces 152 of each of the ten battery modules BM7-BM16 of battery module row R3 are shown, in schematic form. Coolant outlets 150 and the coolant outlet manifold 1100 are both omitted from FIG. 18.

As illustrated, the coolant inlet manifold 1000 is a tree-like network of three categories of conduits: primary conduits 1010, of which there is only one in coolant inlet manifold 1000, secondary conduits 1020, which branch from the primary conduit 1010, and tertiary conduits 1030, which branch from the secondary conduits 1020. These three categories of conduits may alternatively be referred to as primary supply conduits 1010, secondary supply conduits 1020, and tertiary supply conduits 1030, respectively.

In the depicted coolant inlet manifold 1000, the primary conduit 1010 is oriented horizontally and is substantially straight. In the present embodiment, the primary conduit 1010 is defined by the following modular components interconnected as shown in FIG. 15: the two upstream-most conduit sections 1002; the run portion 1202 of the upstream-most through fitting 1200; and the upstream half (i.e., upstream of the branch portion 1204) of the run portion 1202 of the through fitting 1200 generally between battery module groups G2 and G3 (defined below). An upstream end 1011 of the primary conduit 1010 receives liquid coolant from the coolant source 202.

There are three secondary conduits 1020-1, 1020-2, and 1020-3 (generically or collectively secondary conduit(s) 1020) in the coolant inlet manifold 1000. Each secondary conduit 1020 branches from, and is in fluid communication with, the primary conduit 1010. Moreover, each secondary conduit 1020 is associated with a respective a group of battery modules. In this context, the term “group of battery modules” (or “battery module group”) refers to a subset of battery modules of a battery system, such as a contiguous subset of battery modules in a row of battery modules. As shown in FIG. 18, a first secondary conduit 1020-1 is associated with a battery module group G1 containing four battery modules BM7-BM10. The second secondary conduit 1020-2 is associated with a battery module group G2 containing three battery modules BM11-BM13. The third secondary conduit 1020-3 is associated with battery module group G3 containing three battery modules BM14-BM16.

In the present embodiment, the first secondary conduit 1020-1 is defined by the following modular components interconnected as shown in FIG. 15: the branch portion 1204 of the through fitting 1200 depicted generally between battery module groups G1 and G2 in FIG. 18; an elbow conduit 1004; the run portions 402 of each of two through fittings 400 associated with battery modules BM9 and BM10; the upstream half of the run portion 402 of the through fitting 400 associated with battery module BM8; and two conduit sections 550. With the exception of the elbow conduit 1004, the first secondary conduit 1020-1 is substantially straight.

The structure of the second secondary conduit 1020-2 is similar to that of the first secondary conduit 1020-1. An exception is that, because battery module group G2 comprises only three battery modules rather than four as in group G1, the number of through fittings 400 and conduit sections 550 in secondary conduit 1020-2 is reduced by one.

The third secondary conduit 1020-3 is defined by the following modular components interconnected as shown in FIG. 15: a downstream part of the run portion 1202 of the through fitting 1200 depicted generally between battery module groups G2 and G3 in FIG. 18; conduit section 1002; elbow fitting 1300; elbow conduit 1004; the run portion 402 of the through fitting 400 associated with battery module BM16; conduit section 550; and the upstream half of the run portion 402 of the through fitting 400 associated with battery module BM15. The third secondary conduit 1020-3 is accordingly longer than each of the other two secondary conduits 1020-1 and 1020-2 and, unlike the secondary conduits 1020-1 and 1020-2, defines a 180-degree turn. This illustrates the fact that conduits at the same hierarchical level of a coolant inlet manifold need not necessarily conform to a uniform shape (the same also being true for conduits at the same hierarchical level of a coolant outlet manifold).

In the present embodiment, downstream portions of all three of the secondary conduits 1020 are substantially colinear with one another and substantially parallel to the primary conduit 1010 (with the exception of the branch portions 1204 of the through fittings 1200, elbow fitting 1300, and the elbow conduits 1004). The direction of liquid coolant flow in each of the secondary conduits 1020 is opposite to the direction of liquid coolant flow in the primary conduit 1010 in the present embodiment.

A plurality of tertiary conduits 1030 branches from each of the secondary conduits 1020 respectively. Each tertiary conduit 1030 is fluidically coupled with the coolant inlet 148 of a respective one of the battery modules of the battery module group with which the secondary conduit 1020 is associated.

For example, in FIG. 18, the secondary conduit 1020-1 associated with battery module group G1 has four tertiary conduits 1030-1, 1030-2, 1030-3, and 1030-4 (generically or collectively tertiary conduit(s) 1030) branching therefrom. Three of the tertiary conduits 1030-1, 1030-2, and 1030-3 are formed from the three branch portions 404 (see FIGS. 7A-7D) of the three respective through fittings 400 used to construct the secondary conduit 1020 of the present embodiment (see FIG. 15). The remaining, downstream-most tertiary conduit 1030-4 is collectively defined by the downstream half of the run portion 402 of the through fitting 400 associated with battery module BM8, the end fitting 500 associated with battery module BM7, and the interconnecting conduit section 550.

Each of the other two secondary conduits 1020 of FIG. 18 also has multiple tertiary conduits 1030 branching therefrom. However, the number of tertiary conduits 1030 branching from each of the other two secondary conduits 1020 is three, not four. The reason is that each of battery module groups G2 and G3 has three battery modules, rather than four as in battery module group G1. In general, the number of tertiary conduits 1030 for a battery module group may match the number of battery modules in that group (presuming a single coolant inlet 148 per battery module, as in the present example).

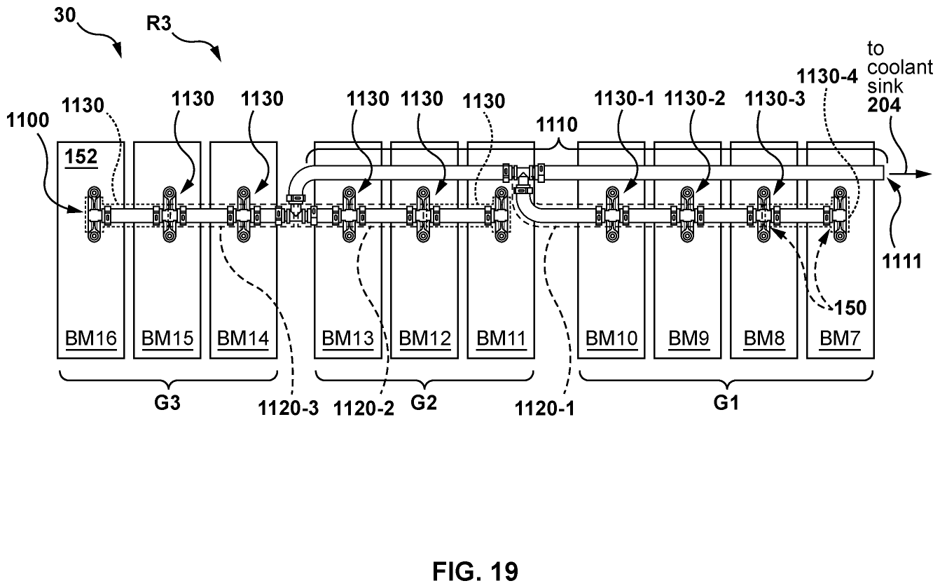

FIG. 19 is an isometric view of the coolant outlet manifold 1100 of FIG. 15 that emphasizes its hierarchical structure, which is similar to that of coolant inlet manifold 1000. The conventions of FIG. 19 are similar to those of FIG. 18. For clarity, the coolant inlets 148 and coolant inlet manifold 1000 are omitted from FIG. 19.

As illustrated, the coolant outlet manifold 1100 is a tree-like network of three categories of conduits: primary conduits 1110, of which there is only one in coolant outlet manifold 1100, secondary conduits 1120, which branch from the primary conduit 1110, and tertiary conduits 1130, which branch from the secondary conduits 1120. These may be referred to as primary return conduits 1110, secondary return conduits 1120, and tertiary return conduits 1130, respectively.

In FIG. 19, the sole primary return conduit 1110 of coolant inlet manifold 1100 is horizontally oriented and substantially straight. In the present embodiment, the primary return conduit 1110 is defined by the following modular components interconnected as shown in FIG. 15: two conduit sections 1002; the run portion 1202 of the through fitting 1200 located generally between battery module groups G1 and G2; an elbow conduit 1004; and the branch portion of the through fitting 1200 located generally between battery module groups G2 and G3. A downstream end 1111 of the primary return conduit 1110 channels liquid coolant returning from all of the battery modules BM7-BM16 towards the coolant sink 204. The coolant flow direction through primary return conduit 1110 in FIG. 19 is left to right.

There are three secondary return conduits 1120-1, 1120-2, and 1120-3 (generically or collectively secondary return conduit(s) 1120) in coolant outlet manifold 1100. Each secondary return conduit 1120-1, 1120-2, and 1120-3 is associated with a respective one of battery module groups G1, G2, and G3. Moreover, each secondary return conduit 1120 branches from, and is in fluid communication with, the primary return conduit 1110.

In the present embodiment, the first secondary return conduit 1120-1 is defined by the following modular components interconnected as shown in FIG. 15: elbow conduit 1004; the run portions 402 of each of two through fittings 400 associated with battery modules BM9 and BM10; the downstream half of the run portion 402 of the through fitting 400 associated with battery module BM8; and three conduit sections 550. With the exception of the elbow conduit 1004, the first secondary return conduit 1120-1 is substantially straight.

The structure of each of the other two secondary return conduits 1120-2 and 1120-3 in FIG. 19 is similar to that of first secondary return conduit 1120-1. An exception is that, because each of battery module groups G2 and G3 comprises only three battery modules rather than four as in group G1, the number of through fittings 400 and conduit sections 550 in each of the two other secondary return conduits 1120-2 and 1120-3 is reduced by one. Another exception is that each of these two secondary return conduits 1120-2 and 1120-3 includes a respective part of the run portion 1202 of through fitting 1200 (FIG. 16) and lacks any elbow conduit 1004. For clarity, the direction of coolant flow through the secondary return conduits 1120-2 and 1120-3 is right-to-left and left-to-right, respectively.

A plurality of tertiary return conduits 1130 branches from each of the secondary return conduits respectively. Each tertiary return conduit 1130 is fluidically coupled with the coolant outlet 150 of a respective one of the battery modules of the battery module group with which its secondary return conduit 1120 is associated.

For example, in FIG. 19, the secondary return conduit 1120-1 has four tertiary return conduits 1130-1, 1130-2, 1130-3, and 1130-4 (generically or collectively tertiary return conduit(s) 1130) branching therefrom. Three of the tertiary return conduits are formed from the respective three branch portions 404 (see FIGS. 7A-7D) of the three respective through fittings 400 used to construct the secondary return conduit 1120 (see FIG. 15). The remaining, upstream-most tertiary return conduit 1130-4 is collectively defined by the upstream half of the run portion 402 of the through fitting 400 associated with battery module BM8, the end fitting 500 associated with battery module BM7, and the interconnecting conduit section 550.

Each of the other two secondary return conduits 1120-2 and 1120-3 of FIG. 19 also has multiple tertiary return conduits 1130 branching therefrom. However, the number of tertiary return conduits 1130 branching from each of the other two secondary return conduits 1120 is three, not four. In general, the number of tertiary return conduits 1130 for a battery module group may match the number of battery modules in that group (presuming a single coolant outlet 150 per battery module, as in the present example).

The hierarchical nature of the coolant inlet manifold 1000, and the corresponding coolant outlet manifold 1100, may improve the uniformity of coolant fluid distribution to the battery modules BM7-BM16 through the creation of shorter coolant branches having their own associated downstream ends. For example, the coolant inlet manifold 200 of FIG. 6 has one long supply conduit 220 terminating at the downstream end 201 (see FIG. 7). The momentum of the coolant fluid might tend to carry the coolant fluid towards the end fitting 500 associated with battery module BM16 at the cost of reduced flow to at least some of the upstream battery modules (e.g., battery modules BM8-BM14). In contrast, in place of the long supply conduit 220, the coolant inlet manifold 1000 of FIG. 18 has three shorter secondary conduits 1020. The effect of coolant fluid momentum along the shorter secondary conduits 1020 may be reduced compared to the longer supply conduit 220, allowing for improved uniformity of coolant fluid distribution to the battery modules in each of the groups G1, G2, G3. Thus, although the coolant inlet manifold 1000 may include more components than the coolant inlet manifold 200 of FIG. 6, for example, it may provide the benefit of having improved uniformity of coolant fluid distribution.

Limiting the number of battery modules per battery module group may promote more uniform heating/cooling rates. In the present embodiment, the upper limit number for coolant inlet manifold 1000 is four (battery module group G1). In alternative coolant inlet manifold embodiments, the upper limit may be one, two or three battery modules.

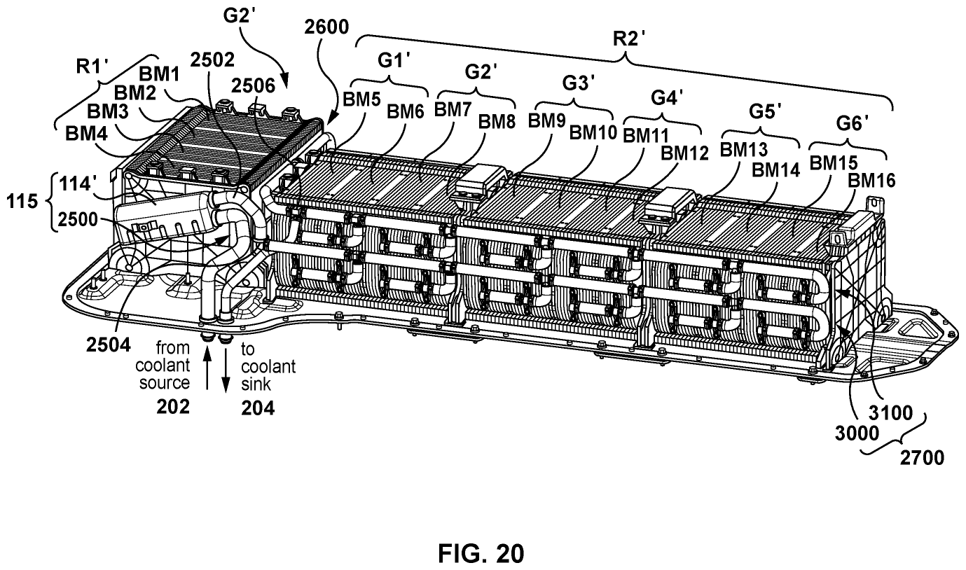

In some embodiments, the hierarchical coolant inlet manifold 1000 and/or the hierarchical coolant outlet manifold 1100 may include flow restrictors such as those described above with reference to FIGS. 11-14. The flow restrictors may help to further improve the uniformity of coolant fluid distribution to the battery modules BM7-BM16. A coolant manifold system that utilizes a tree-like hierarchy of supply and return conduits along with flow restrictors—albeit different flow restrictors from those described in connection with FIGS. 11 to 14—is depicted in FIGS. 20-26.

FIG. 20 is an isometric view of an alternative battery system 30′ that may form part of a snowmobile 10 (FIG. 1) or other electric vehicle. Like the battery system 30 of FIG. 3, the battery system 30′ (or “simply battery 30”) includes sixteen battery modules BM1-BM16. However, the arrangement of the battery modules in FIG. 20 differs from that of FIG. 3. In particular, the sixteen battery modules of FIG. 20 are arranged in two rows R1′ and R2′ rather than three rows R1-R3. The first row R1′ includes four battery modules BM1-BM4, and the second row R2′ includes the remaining twelve battery modules BM5-BM16. The twelve battery modules of row R2′ are arranged in six battery module groups G1′-G6′ of two battery modules each: battery modules BM5 and BM6; BM7 and BM8; BM9 and BM10; BM11 and BM12; BM13 and BM14; and BM15 and BM16, respectively.

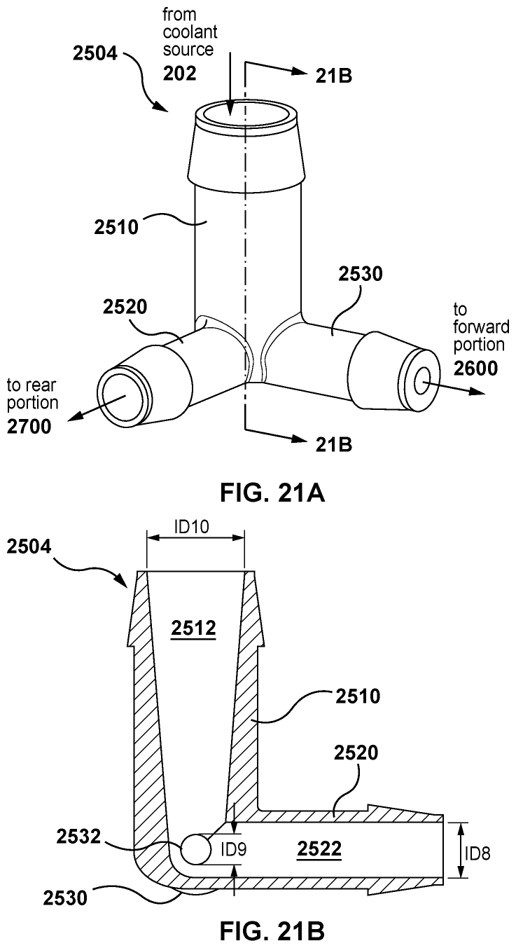

Also depicted in FIG. 20 are portions of a thermal management system 115′ including a heater 114′ and a coolant manifold system 2500 for promoting uniform heating rates and/or cooling rates of the battery system 30′. The coolant manifold system 2500 has a forward portion 2600 associated with battery module row R1′ and a rear portion 2700 associated with battery module row R2′. Both portions 2600, 2700 of the coolant manifold system 2500 are supplied from a common coolant source 202 via heater 114′. A supply conduit 2502 from the heater 114′ feeds a three-way junction fitting 2504, which unevenly or unequally splits the supply coolant stream into two streams destined for the forward portion 2600 and rear portion 2700 as described below. In some embodiments, the three-way junction fitting 2504 splits the supply coolant stream proportional to, or otherwise based on, the number of battery modules in the battery modules rows R1′, R2′. The three-way junction fitting 2540 is depicted in isolation in FIGS. 21A and 21B.

FIG. 21A illustrates the three-way junction fitting 2504 of FIG. 20 in isometric view. FIG. 21B is a cross-section of the fitting 2504 taken along line 21B-21B of FIG. 21A. The fitting 2504 has three tubular fitting portions, including a straight inlet portion 2510 and two straight outlet portions 2520, 2530 branching from a common branch point of the inlet portion 2510. The three tubular fitting portions 2510, 2520, and 2530 are in fluid communication with one another and, in the present embodiment, are mutually orthogonal. Each of the tubular fitting portions 2510, 2520, and 2530 has a cylindrical outer surface with a barbed end and defines an internal passage. The internal passages 2522 and 2532 of fitting portions 2520 and 2530 respectively are cylindrical. In contrast, the internal passage 2512 of fitting portion 2510 is tapered inwardly towards the branch point of the other two passages 2522 and 2532. However, the shape of passages 2522, 2532, 2512 are not limited herein and may change based on the manufacturing process used.

Each tubular portion 2510, 2520, and 2530 of the three-way junction fitting 2504 has a distinct inner diameter in the present embodiment. In one embodiment, the inner diameters ID8 and ID9 of passages 2522 and 2532 may be 9 millimeters and 5 millimeters respectively, and the inner diameter ID10 of the passage 2512 may taper from 16 millimeters at an open end of the passage 2512 to a lesser value at the branch point of the other passages 2522 and 2532. The lesser value may be substantially equal to the inner diameter ID8 of the larger passage 2522.

The rationale for the relative sizing of inner diameters ID8 and ID9 described above may be to act as, or to provide, a flow restrictor in the supply conduit for each of portions 2700 and 2600 respectively of the coolant manifold system 2500. The inner diameters may be chosen based in part upon the number of battery modules (presuming battery modules of uniform size) associated with the respective portions 2600 and 2700 of the coolant manifold system 2500. A larger inner diameter passage (i.e., a passage having a larger transverse cross-sectional area) may be used to supply coolant to a portion of the coolant manifold system distributing coolant to a larger number of battery modules. Conversely, a smaller inner diameter (i.e., a passage having a smaller transverse cross-sectional area) may be used to supply coolant to a portion of the coolant manifold system distributing coolant to a smaller number of battery modules.

Referring again to FIG. 20, both portions 2600, 2700 of the coolant manifold system 2500 return coolant to a common coolant sink 204. The coolant sink 204 is connected to another three-way junction fitting 2506, which collects and combines coolant flow from the forward portion 2600 and rear portion 2700. The three-way junction fitting 2506 may be a tee junction that includes a first tubular portion connected to the forward portion 2600 and a second tubular portion connected to the rear portion 2700, where the first and second tubular portions both branch from an outlet tubular portion connected to the coolant sink 204. Similar to the three-way junction fitting 2504, the passages defined by the first tubular portion, the second tubular portion and the outlet tubular portion of the three-way junction fitting 2504 may vary in size to more evenly distribute coolant flow between the forward portion 2600 and rear portion 2700. For example, the passage of the first tubular portion connected to the forward portion 2600 may be smaller (e.g., narrower in diameter) than the passage of the second tubular portion connected to the rear portion 2700. The passage of the second tubular portion and the passage of the outlet tubular portion may be similar in size. In an embodiment, the inner diameter defined by the first tubular portion is slightly more than one-half of the inner diameter defined by the second tubular portion and/or the outlet tubular portion.

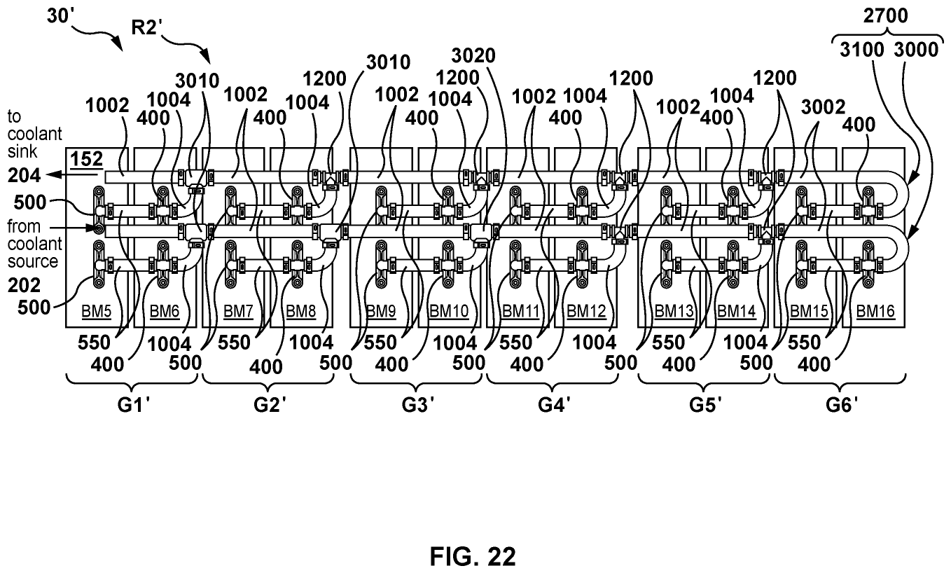

FIG. 22 is an isometric view of the rear portion 2700 of the coolant manifold system 2500 that illustrates its hierarchical nature. FIG. 22 adopts similar conventions to those of FIG. 15.

The rear portion 2700 of the coolant manifold system 2500 includes a coolant inlet manifold 3000 and a corresponding coolant outlet manifold 3100, both constructed from modular components in the present embodiment. Some of the modular components are identical to those used to construct coolant manifold system 998 of FIG. 15, including conduit sections 550 and 1002, through fittings 400 and 1200, end fittings 500, and elbow conduits 1004. Other modular components, including “J” conduit sections 3002, reducer through fitting 3010, and reducer through fitting 3020, are newly introduced.

Conduit section 3002 is similar to conduit section 1002 but incorporates a 180-degree bend at one end. The transverse cross-sectional area of the passage defined by conduit section 3002 may be the same as that defined by conduit section 1002.

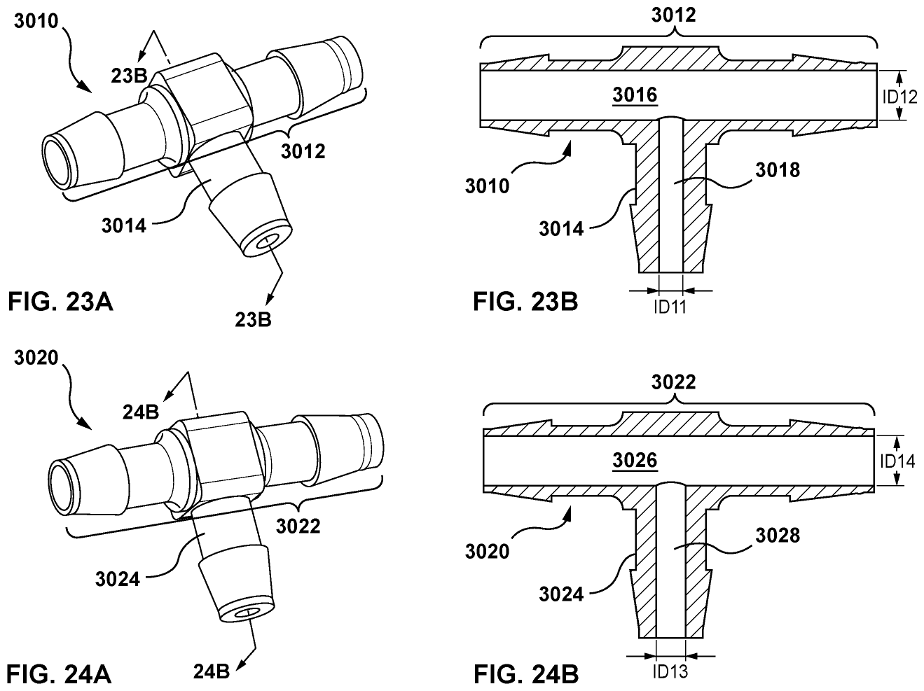

Reducer through fitting 3010 is depicted in FIG. 23A in isolation in isometric view. A cross-section of the fitting 3010 taken along line 23B-23B of FIG. 23A is depicted in FIG. 23B. As illustrated, reducer through fitting 3010 is a tee junction similar to through fitting 1200. The through fitting 3010 has a run portion 3012 and a branch portion 3014 extending orthogonally from the run portion 3012. Each of the run portion 3012 and branch portion 3014 defines an internal passage, referred to as the run passage 3016 and the branch passage 3018 respectively, both of which are cylindrical in the present embodiment. The fitting 3010 is referred to as a “reducer” through fitting because the inner diameter ID11 of the branch passage 3018 is smaller than the inner diameter ID12 of the run passage 3016. In this embodiment, inner diameter ID11 is less than one-half of inner diameter ID12.

Another reducer through fitting 3020 is depicted in FIG. 24A in isometric view and in FIG. 24B in cross section taken along line 24B-24B of FIG. 24A. Reducer through fitting 3020 is similar to reducer through fitting 3010, having a run portion 3022 and a branch portion 3024 extending orthogonally from the run portion 3022. As with through fitting 3010, the run portion 3022 of through fitting 3020 defines an internal passage 3026, and the branch portion 3024 defines an internal passage 3028, both of which are cylindrical in the present embodiment. However, the relative inner diameters of the branch passage 3028 and the run passage 3026 are different from those of the corresponding passages 3018 and 3016 of through fitting 3010. In particular, the branch passage 3028 of through fitting 3020 is not quite as restrictive as the branch passage 3018 of through fitting 3010. In this embodiment, inner diameter ID13 of branch passage 3028 is slightly more than one-half of inner diameter ID14 of run passage 3026. It will be appreciated that the branch portions 3014 and 3024 of the reducer through fittings 3010 and 3020 respectively can act as flow restrictors in the fluid connection between primary conduits and secondary conduits, as described below.

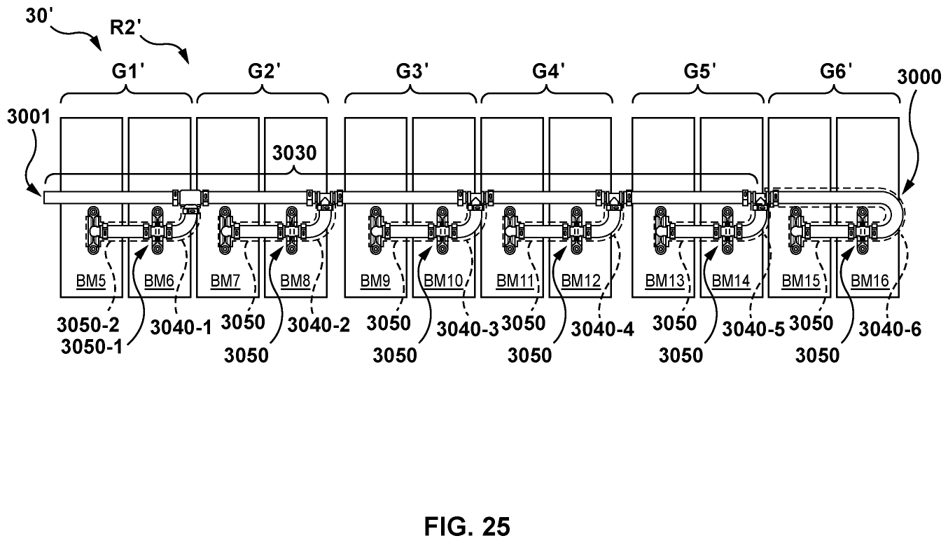

FIG. 25 is an isometric view of the coolant inlet manifold 3000 of FIG. 22 that emphasizes its hierarchical structure. The coolant inlet manifold 3000 supplies coolant to ten battery modules BM5-BM16 in parallel. FIG. 25 adopts similar conventions to those of FIG. 18. For clarity, coolant outlet manifold 3100 is omitted from FIG. 25.

The coolant inlet manifold 3000 is a tree-like network of three categories of conduits: primary conduits 3030, of which there is only one in coolant inlet manifold 3000, secondary conduits 3040, which branch from the primary conduit 3030, and tertiary conduits 3050, which branch from the secondary conduits 3040. These three categories of conduits may alternatively be referred to as primary supply conduits 3030, secondary supply conduits 3040, and tertiary supply conduits 3050, respectively. In this context, the term “branching” is as defined above.

In the depicted coolant inlet manifold 3000, the primary conduit 3030 is oriented horizontally and is substantially straight. In the present embodiment, the primary conduit 3030 is defined by the following modular components interconnected as shown in FIG. 22: five conduit sections 1002; the run portion 3012 of each of the two through fittings 3010 located generally near battery modules BM6 and BM8; the run portion 3022 of the through fitting 3020 located generally near battery module BM10; the run portion 1202 of the through fitting 1200 located generally near battery module BM12; and the upstream half (i.e., upstream of the branch portion 1204) of the run portion 1202 of the through fitting 1200 located generally near battery module BM14. An upstream end 3001 of the primary conduit 3030 receives liquid coolant from the coolant source 202 via outlet portion 2520 of three-way junction 2504 (see FIGS. 20 and 21A).

There are six secondary conduits 3040-1, 3040-2, 3040-3, 3040-4, 3040-5, and 3040-6 (generically or collectively secondary conduit(s) 3040) in the coolant inlet manifold 1000. Each secondary conduit 3040 branches from, and is in fluid communication with, the primary conduit 3030. Moreover, each secondary conduit 3040-1 to 3040-6 is associated with a respective one of the six groups G1′-G6′ of battery modules of row R2′.

In the present embodiment, the first secondary conduit 3040-1 is defined by the following modular components interconnected as shown in FIG. 22: the branch portion 3014 of the through fitting 3010 (FIG. 23A) located near battery module BM6; an elbow conduit 1004; and the upstream half of the run portion 402 of the through fitting 400 associated with battery module BM6. The first secondary conduit 3040-1 is substantially curved through 90 degrees. The structure of the next secondary conduit 3040-2 is similar to that of the first secondary conduit 3040.

The structure of the third secondary conduit 3040-3 is similar to that of the first two. An exception is that the third secondary conduit 3040-3 includes the less restrictive branch portion 3024 of reducer through fitting 3020 (located near battery module BM10) rather than the more restrictive branch portion 3014 of a reducer through fitting 3010.

The structure of the fourth and fifth secondary conduits 3040-4 and 3040-5 is similar to that of the third. An exception is that each of the fourth and fifth secondary conduits 3040-4 and 3040-5 includes the (non-restrictive) branch portion 1204 of a respective “standard” through fitting 1200 rather than the restrictive branch portion 3024 of a reducer through fitting 3020.

The sixth secondary conduit 3040-6 is defined by the following modular components interconnected as shown in FIG. 22: the downstream portion of the run portion 1202 of the through fitting 1200 located near battery module BM14; the “J” conduit section 3002; and the upstream half of the run portion 402 of the through fitting 400 associated with battery module BM16. The sixth secondary conduit 3040-6 is longer than any of other secondary conduits 3040 and, unlike any of the other secondary conduits 3040, defines a 180-degree turn.

A plurality of tertiary conduits 3050 branches from each of the secondary conduits 3040 respectively. Each tertiary conduit 3050 is fluidically coupled with the coolant inlet 148 (not expressly depicted) of a respective one of the battery modules of the battery module group with which the secondary conduit 3040 is associated.

For example, in FIG. 25 the secondary conduit 3040-1 has two tertiary conduits 3050-1 and 3050-2 (generically or collectively tertiary conduit(s) 3050) branching therefrom. The first tertiary conduit 3050-1 is formed from the branch portion 404 (see FIGS. 7A-7D) of the through fitting 400 located near battery module BM6. The second, downstream-most tertiary conduit 3050-2 is collectively defined by the downstream half of the run portion 402 of the through fitting 400 associated with battery module BM6, the end fitting 500 associated with battery module BM5, and the interconnecting conduit section 550.

Each of the remaining five secondary conduits 3040-2 to 3040-6 of coolant inlet manifold 3000 has two tertiary conduits 3050 branching therefrom similar in structure to what is described above. In alternative embodiments, the number of tertiary conduits per secondary conduit may be greater than or less than two and/or may vary between battery module groups.

It will be appreciated that the restricted branch portions 3014 of the two reducer through fittings 3010 of coolant inlet manifold 3000 act as flow restrictors into the two secondary conduits 3040-1 and 3040-2 (FIG. 25) closest to the upstream coolant source, where coolant pressure may be highest. In this way, the restricted branch portions 3014 may reduce or avoid excess coolant flow to battery modules BM5-BM8 caused by the relatively high coolant pressure at the upstream end of the primary conduit 3030. The lesser restriction of restricted branch portion 3024 of reducer through fitting 3020 acts as a lesser flow restrictor into the secondary conduit 3040-3, in view of what may be a lower coolant pressure at this point along the primary conduit 3030 further from the coolant source.

In this embodiment, no flow restrictors as such are used to restrict flow into the remaining (downstream) secondary conduits 3040-4 to 3040-6. The reason may be that coolant pressure along that portion of the primary conduit 3030 may be too low to warrant their use. As well, coolant inertia along primary conduit 3030 may be insufficient in this embodiment to warrant the use of a flow restrictor for the terminal secondary conduit 3040-6, e.g., as in the coolant inlet manifold 900 of FIG. 11.

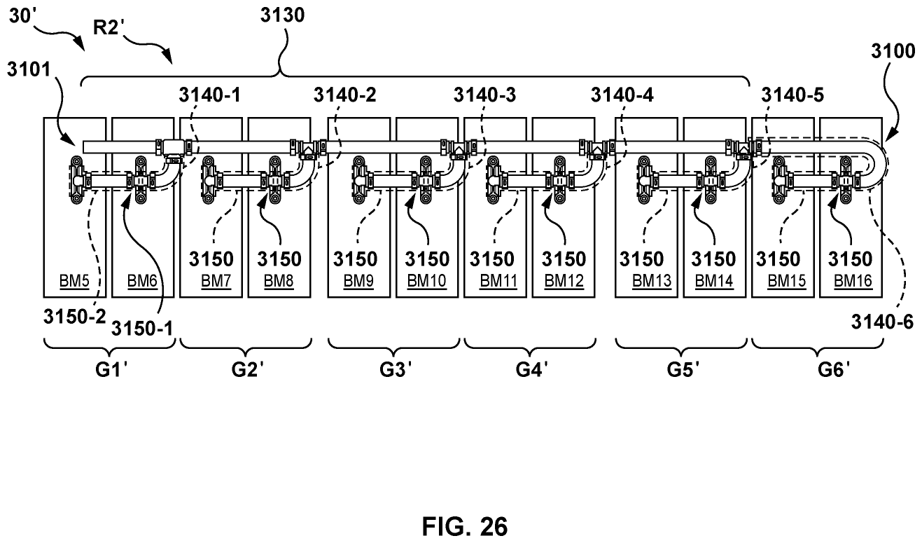

FIG. 26 is an isometric view of the coolant outlet manifold 3100 of FIG. 22 that emphasizes its hierarchical structure, which is similar to that of coolant inlet manifold 3000. The conventions of FIG. 26 are similar to those of FIG. 25. For clarity, the coolant inlet manifold 3000 is omitted from FIG. 26.

The coolant outlet manifold 3100 is a tree-like network of three categories of conduits: primary conduits 3130, of which there is only one in coolant outlet manifold 3100, secondary conduits 3140, which branch from the primary conduit 3130, and tertiary conduits 3150, which branch from the secondary conduits 3140. These may alternatively be referred to as primary return conduits 3130, secondary return conduits 3140, and tertiary return conduits 3150, respectively.

In FIG. 26, the sole primary return conduit 3130 is oriented horizontally and is substantially straight. In the present embodiment, the primary return conduit 3130 is defined by the following modular components interconnected as shown in FIG. 22: five conduit sections 1002; the run portion 312 of a through fitting 3010 located near battery module BM6; the run portions 1202 of the three through fittings 1200 located near battery modules BM8, BM10, and BM12 respectively; and the upstream half (i.e., upstream of the branch portion 1204) of the run portion 1202 of the through fitting 1200 located generally near battery module BM14. A downstream end 3101 of the primary return conduit 3130 channels liquid coolant returning from all of the battery modules BM5-BM16 towards the coolant sink 204. The coolant flow direction through primary return conduit 3130 in FIG. 26 is right-to-left.

There are six secondary return conduits 3140-1, 3140-2, 3140-3, 3140-4, 3140-5, and 3140-6 (generically or collectively secondary return conduits(s) 3140) in the coolant outlet manifold 3100. Each secondary return conduit 3140 branches from, and is in fluid communication with, the primary return conduit 3130. Moreover, each secondary return conduit 3140-1 to 3140-6 is associated with a respective one of the six groups G1′-G6′ of battery modules of row R2′.

In the present embodiment, the first secondary return conduit 3140-1 is defined by the following modular components interconnected as shown in FIG. 22: the branch portion 3014 of the reducer through fitting 3010 (FIG. 23A) located near battery module BM6; an elbow conduit 1004; and the upstream half of the run portion 402 of the through fitting 400 associated with battery module BM6. The first secondary return conduit 3140-1 is substantially curved through 90 degrees. The restrictive branch portion 3014 of the reducer through fitting 3010 may be chosen to act as a flow restrictor at this location, where coolant pressure along primary return conduit 3130 may be lowest.

The structure of each of the next four secondary return conduits 3140, which are associated with battery module groups G2′, G3′, G4′, and G5′ respectively, is similar to that of the first. An exception is that each of these four secondary return conduits 3140 includes the “non-restrictive” branch portion 1204 of a respective standard through fitting 1200 rather than the branch portion 3014 of a reducer through fitting 3010.

The sixth secondary return conduit 3140, which is associated with battery module group G6′, is defined by the following modular components interconnected as shown in FIG. 22: the upstream portion of the run portion 1202 of the through fitting 1200 located near battery module BM14; the “J” conduit section 3002; and the upstream half of the run portion 402 of the through fitting 400 associated with battery module BM16. The sixth secondary return conduit 3140-6 is longer than any of other secondary return conduits 3140 and, unlike any of the other secondary return conduits 3140, defines a 180-degree turn.

A plurality of tertiary return conduits 3150 branches from each of the secondary return conduits 3140 respectively. Each tertiary return conduit 3150 is fluidically coupled with the coolant outlet 150 (not expressly depicted) of a respective one of the battery modules of the battery module group with which secondary return conduit 3140 is associated.

For example, in FIG. 25 the secondary return conduit 3140-1 associated with battery module group G1′ has two tertiary return conduits 3150-1 and 3150-2 (generically or collectively secondary return conduit(s) 3150) branching therefrom. One of the tertiary return conduits 3150-1 is formed from the branch portion 404 (see FIGS. 7A-7D) of the through fitting 400 located near battery module BM6. The remaining, upstream-most tertiary return conduit 3150-2 is collectively defined by the upstream half of the run portion 402 of the through fitting 400 associated with battery module BM6, the end fitting 500 associated with battery module BM5, and the interconnecting conduit section 550.

Each of the remaining five secondary return conduits 3140-2 to 3140-6 of coolant outlet manifold 3100 has two tertiary return conduits 3150 branching therefrom having a similar structure to that of secondary return conduit 3150-1 and 3150-2. It will be appreciated that the number of tertiary return conduits 3150 per secondary return conduit 3140 may be greater than or less than two in alternative embodiments and/or may very between battery module groups.

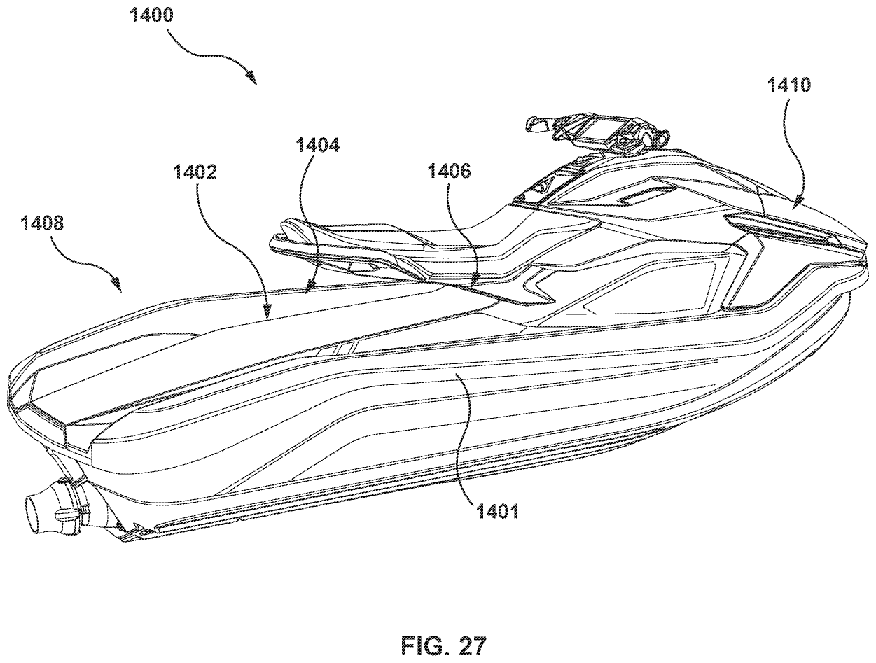

FIG. 27 is a perspective view of another example electric vehicle 1400, namely, an electric personal watercraft. The electric vehicle 1400 has a body 1401 with a rear section 1408 and a front section 1410. The body 1401 houses components including a battery system 1402 and a thermal management system 1404.

The battery system 1402 of electric vehicle 1400 may, in some respects, be similar to the battery system 30 described above. For example, the battery system 1402 may have a logical structure as depicted in FIG. 4. Further, the number of battery modules 142 in the battery system 1402 may be sixteen, like in battery system 30, although this number may vary between embodiments. The battery modules 142 may each have the same physical structure depicted in simplified form in FIG. 5.

In other respects, the battery system 1402 of FIG. 27 may differ from the battery system 30 of FIGS. 3 and battery system 30′ of FIG. 20. For example, the physical layout of battery modules 142 of the battery system 1402 may differ from what is shown in FIGS. 3 and 20. For example, the number of rows of battery modules, the number of battery modules per row, and the orientation of the battery modules and of the battery module rows may be different from what is shown in FIGS. 3 and 20. The physical layout of battery modules 142 may be dictated in part by the shape and internal structures of the electric vehicle 1400 (FIG. 27), which differ from those of electric vehicle 10 (FIG. 1).

Some of the components of the thermal management system 1404 of the electric vehicle 1400 of FIG. 27 may be similar or identical to those of thermal management system 115 of FIG. 4. These may for example include a pump for circulating liquid coolant in a closed loop to and from the battery modules, a heater, a heat exchanger, temperature sensors, and a controller (none of these being expressly illustrated in FIG. 27). Other components of thermal management system 1404 may differ from their counterparts described above for electric vehicle 10.

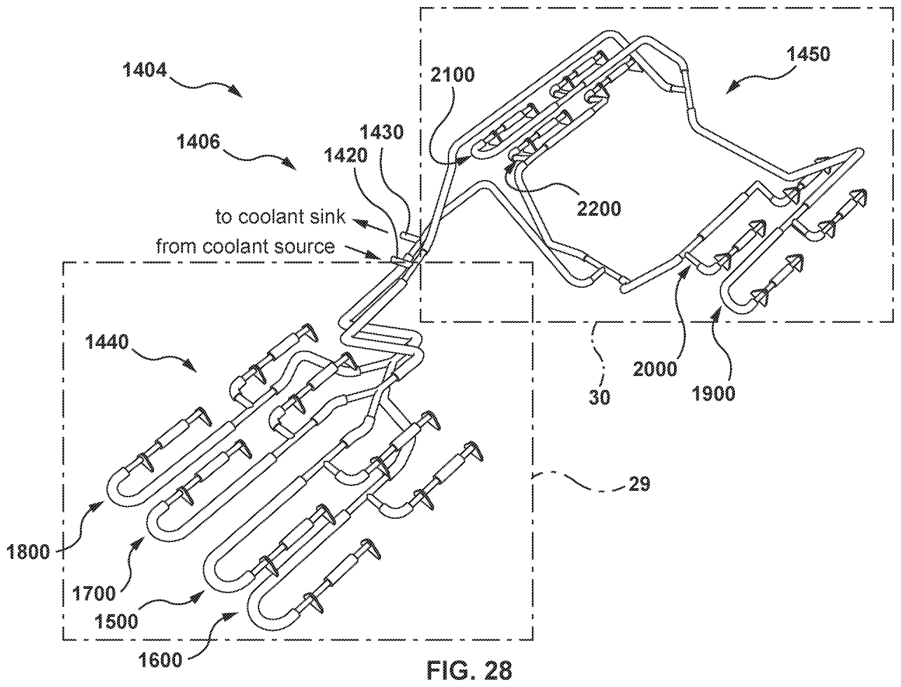

For example, FIG. 28 depicts a coolant manifold system 1406 of electric vehicle 1400 whose structure and shape is different from that of coolant manifold system 198 of FIG. 6 and coolant manifold system 2500 of FIG. 20. It will be appreciated that, in FIG. 28, the coolant manifold system 1406 is depicted in terms of the passages defined by the modular components from which the coolant manifold system 1406 may be constructed rather than the assembly of modular components themselves. The conventions of FIG. 28 are accordingly similar to those of FIG. 10, described above.

The modular components from which the coolant manifold system 1406 of FIG. 28 may be constructed may be similar to those used to construct coolant manifold system 998 of FIG. 15. These components may for example include conduit sections 550 and 1002, through fittings 400 and 1200, end fittings 500, elbow fittings 1004 and 1300, and hose clamps 552, all of which are described above. In alternative embodiments, custom (non-modular) components may be used to construct the coolant manifold system 1406.

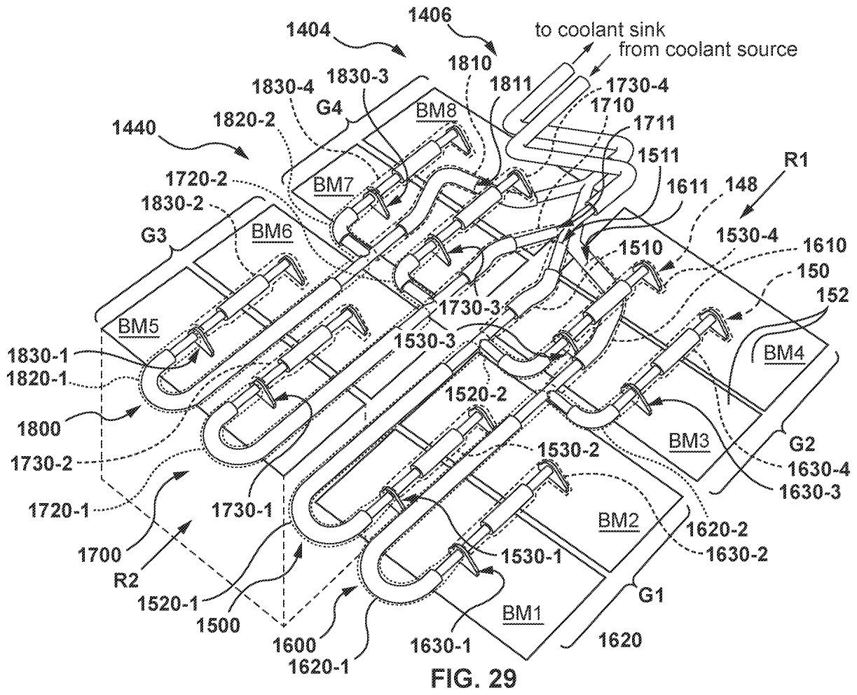

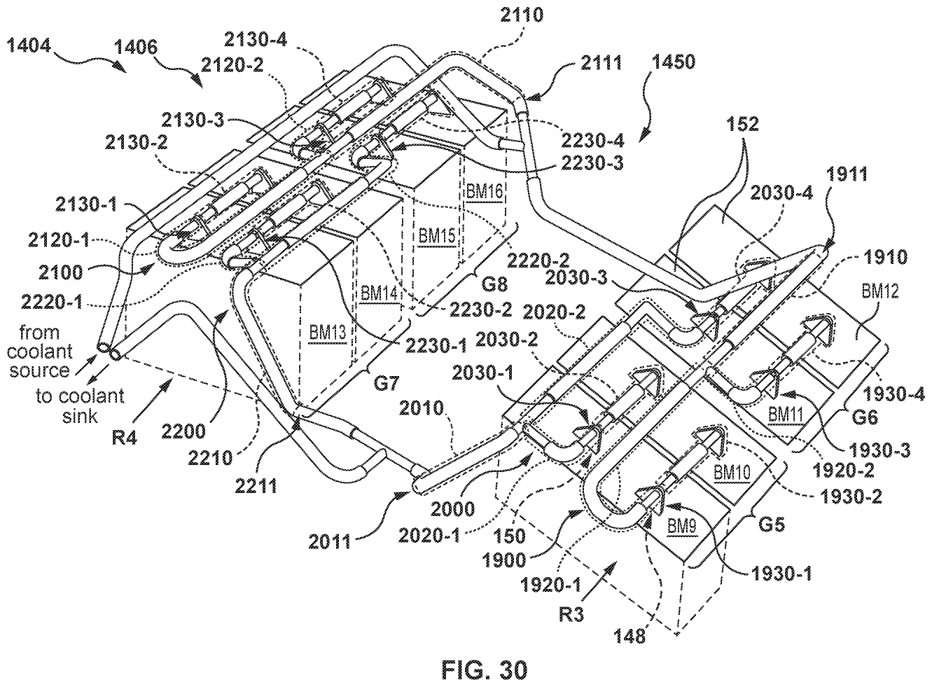

The coolant manifold system 1406 of FIG. 28 includes four coolant inlet manifolds 1500, 1700, 1900, and 2100, as well as four respective coolant outlet manifolds 1600, 1800, 2000, and 2200. Each of the coolant inlet manifolds 1500, 1700, 1900, and 2100 is paired with, i.e., corresponds to one of, the coolant outlet manifolds 1600, 1800, 2000, and 2200, respectively. Each of the four pairs of coolant inlet and coolant outlet manifolds 1500 and 1600, 1700 and 1800, 1900 and 2000, and 2100 and 2200 services (i.e., channels coolant to and from) a respective battery module row R1, R2, R3, and R4 (not depicted in FIG. 28), with each coolant inlet manifold 1500, 1700, 1900, and 2100 supplying coolant in parallel to a respective plurality of battery modules. In the present embodiment, each battery module row has four battery modules 142. The first two pairs of coolant inlet manifolds and coolant outlet manifolds 1500 and 1600, and 1700 and 1800, are part of a front portion 1440 of coolant manifold system 1406, which is disposed towards the front section 1410 (FIG. 27) of the electric vehicle 1400. The front portion 1440 is illustrated in greater detail in FIG. 29. The second two pairs of coolant inlet manifolds and coolant outlet manifolds 1900 and 2000, and 2100 and 2200, are part of a rear portion 1450 of coolant manifold system 1406, which is disposed in or towards the rear section 1408 (FIG. 27) of the electric vehicle 1400. The rear portion 1450 is illustrated in greater detail in FIG. 30.

Referring again to FIG. 28, a common coolant supply pipe 1420 supplies coolant from a common coolant source to all of the coolant inlet manifolds 1500, 1700, 1900, and 2100 of the coolant manifold system 1406. Conversely, a common coolant return pipe 1430 channels coolant flowing in the opposite direction from all of the coolant outlet manifolds 1600, 1800, 2000, and 2200 of coolant manifold system 1406 towards a common coolant sink.

FIG. 29 is a perspective view the front portion 1440 of the coolant manifold system 1406 of FIG. 28. The depicted front portion 1440 is used for controlling the temperature of eight battery modules BM1-BM8, arranged in two battery module rows R1, R2 of four battery modules per row, disposed in the rear section 1408 of the electric vehicle 1400. The first battery module row R1 comprises battery modules BM1-BM4, grouped into two battery module groups G1 (battery modules BM1 and BM2) and G2 (battery modules BM3 and BM4). The second battery module row R2 comprises battery modules BM5-BM8, grouped into two battery module groups G3 (battery modules BM5 and BM6) and G4 (battery modules BM7 and BM8).

In FIG. 29, the battery modules BM1-BM8 of battery system 1402 are depicted in simplified form, with only their faces 152 visible. To provide a sense of perspective, the three-dimensional outline of one of the battery modules, battery module BM5, is depicted in dashed lines.

Like the coolant inlet manifold 1000, described above in connection with FIG. 15, each of the coolant inlet manifolds 1500 and 1700 of front portion 1440 has a tree-like, three-level hierarchy of supply conduits. For clarity, as illustrated, neither of the coolant inlet manifolds 1500 and 1700 incorporates flow restrictors, e.g., in the manner described above in connection with FIG. 20. However, in other embodiments, flow restrictors may be implemented to balance coolant flow between the battery modules BM1-BM8.

As illustrated, the coolant inlet manifold 1500 is a tree-like network of three categories of conduits: primary conduits 1510, of which there is only one in coolant inlet manifold 1500, two secondary conduits 1520-1 and 1520-2 (generically or collectively secondary conduit(s) 1520), which branch from the primary conduit 1510, and four tertiary conduits 1530-1, 1530-2, 1530-3, and 1530-4 (generically or collectively tertiary conduit(s) 1530), which branch from the secondary conduits 1520. These three categories of conduits may alternatively be referred to as primary supply conduits 1510, secondary supply conduits 1520, and tertiary supply conduits 1530, respectively. The primary conduit 1510 may be oriented horizontally. An upstream end 1511 of the primary conduit 1510 receives liquid coolant from the coolant source.

Each of the two secondary conduits 1520-1 and 1520-2 branches from, and is in fluid communication with, the primary conduit 1510. Moreover, each secondary conduit 1520-1, 1520-2 is associated with a respective group G1, G2 of battery modules. In the present embodiment, the first secondary conduit 1520-1 has a 180-degree turn shape similar to that of “J” conduit 3002 (FIG. 22), and the second secondary conduit 1520-2 has a 90 degree turn shape similar to that of elbow conduit 1004 (FIG. 15). The direction of liquid coolant flow at a distal end of each of the secondary conduits 1520 is opposite to the direction of liquid coolant flow in the primary conduit 1510 in the present embodiment.

A plurality of tertiary conduits 1530 branches from each of the secondary conduits 1520 respectively. Each tertiary conduit 1530 is fluidically coupled with the coolant inlet 148 of a respective one of the battery modules of the battery module group with which the secondary conduit 1520 is associated. For example, the secondary conduit 1520-1 associated with battery module group G1 has two tertiary conduits 1530-1, 1530-2 branching therefrom, which are fluidically coupled with the coolant inlets 148 of battery modules BM1 and BM2 respectively. The first tertiary conduit 1530-1 has the shape of the branch passage 446 of through fitting 400 (see FIGS. 8D and 10). The second tertiary conduit 1530-2 has a shape similar to that of the tertiary conduit 1030 supplying battery module BM7 in FIG. 18. The other secondary conduit 1520-2 of FIG. 29 also has two tertiary conduits 1530-3, 1530-4 branching therefrom, which are associated with battery modules BM3 and BM4 respectively of battery module group G2. In general, the number of tertiary conduits 1530 for a battery module group may match the number of battery modules in that group (presuming a single coolant inlet 148 per battery module, as in the present example).

The structure of the coolant outlet manifold 1600 of FIG. 29 is analogous to that of its corresponding coolant inlet manifold 1500. More specifically, the coolant outlet manifold 1600 is a tree-like network of three categories of conduits: primary conduits 1610, of which there is only one in coolant outlet manifold 1600, secondary conduits 1620-1 and 1620-2 (generically or collectively secondary conduit(s) 1620), which branch from the primary conduit 1610, and tertiary conduits 1630-1, 1630-2, 1630-3, and 1630-4 (generically or collectively tertiary conduit(s) 1630), which branch from the secondary conduits 1620. These may be referred to as primary return conduits 1610, secondary return conduits 1620, and tertiary return conduits 1630, respectively.

The sole primary return conduit 1610 of coolant inlet manifold 1600 may be horizontally oriented. A downstream end 1611 of the primary return conduit 1610 channels liquid coolant returning from the battery modules BM1-BM4 of battery module row R1 towards the coolant sink.

Each of the two secondary return conduits 1620-1 and 1620-2 is associated with a respective one of battery module groups G1 and G2. Moreover, each secondary return conduit 1620-1 and 1620-2 branches from, and is in fluid communication with, the primary return conduit 1610. The shaping of secondary return conduits 1620-1, 1620-2 is analogous to that of secondary conduits 1520-1, 1520-2 respectively.

A plurality of tertiary return conduits 1630 branches from each of the secondary return conduits respectively. Each tertiary return conduit 1630 is fluidically coupled with the coolant outlet 150 of a respective one of the battery modules of the battery module group with which its secondary return conduit 1620 is associated. For example, the secondary conduit 1620-1 associated with battery module group G1 has two tertiary conduits 1630-1, 1630-2 branching therefrom, which are fluidically coupled with the coolant outlets 150 of battery modules BM1 and BM2 respectively. The other secondary conduit 1620-2 also has two tertiary conduits 1630-3, 1630-4 branching therefrom, which are associated with battery modules BM3 and BM4 respectively of battery module group G2. The shaping of tertiary return conduits 1630-1, 1630-2, 1630-3, and 1630-4 is analogous to that of tertiary conduits 1530-1, 1530-2, 1530-3, and 1530-4 is respectively.

Coolant inlet manifold 1700 and coolant outlet manifold 1800 collectively service battery module row R2. The structure of the coolant inlet manifold 1700 of FIG. 22 is analogous to that of coolant inlet manifold 1500. The coolant inlet manifold 1700 comprises a single primary supply conduit 1710 having an upstream end 1711 and two secondary supply conduits 1720-1, 1720-2 (generically or collectively secondary (supply) conduit(s) 1720). The secondary supply conduits 1720-1 and 1720-2 are associated with battery module groups G3 (comprising battery modules BM5 and BM6) and G4 (comprising battery modules BM7 and BM8) respectively of battery module row R2. The coolant inlet manifold 1700 further comprises four tertiary supply conduits 1730-1, 1730-2, 1730-3, and 1730-4 (generically or collectively tertiary (supply) conduit(s) 1730), each being associated with a respective one of battery modules BM5, BM6, BM7, and BM8.

Similarly, the structure of the coolant outlet manifold 1800 of FIG. 22 is analogous to that of coolant outlet manifold 1600. The coolant outlet manifold 1800 comprises a single primary return conduit 1810 having a downstream end 1811 and two secondary return conduits 18201, 1820-2 (generically or collectively secondary (return) conduit(s) 1820) associated with battery module groups G3 and G4 respectively. The coolant outlet manifold 1800 further comprises four tertiary return conduits 1830-1, 1830-2, 1830-3, and 1830-4 (generically or collectively tertiary (return) conduit(s) 1830), each being associated with a respective one of battery modules BM5, BM6, BM7, and BM8 of battery module row R2.

FIG. 30 is a perspective view the rear portion 1450 of the coolant manifold system 1406 of FIG. 28. The depicted rear portion 1450 is used for controlling the temperature of eight batteries BM9-BM16 of battery system 1402 disposed toward the front section 1410 of the electric vehicle 1400 (FIG. 27). The batteries BM9-BM16 are arranged in two battery module rows R3, R4 of four battery modules per row. The first battery module row R3 comprises battery modules BM9-BM12, grouped into two battery module groups G5 (battery modules BM9 and BM10) and G6 (battery modules BM11 and BM12). The second battery module row R4 comprises battery modules BM13-BM16, grouped into two battery module groups G7 (battery modules BM13 and BM14) and G8 (battery modules BM15 and BM16).

In FIG. 30, the battery modules BM9-BM16 are depicted in simplified form, with only their faces 152 visible. To provide a sense of perspective, the three-dimensional outlines of battery modules BM9 and BM13-BM16 are depicted in dashed lines.

Like the coolant inlet manifolds 1500 and 1700 of FIG. 29, each of the coolant inlet manifolds 1900 and 2100 of rear portion 1450 has a three-level hierarchy of supply conduits and might not incorporate flow restrictors as such, e.g., as disclosed in connection with FIG. 20. Coolant inlet manifold 1900 is a tree-like network of three categories of conduits: a single primary conduit 1910, two secondary conduits 1920-1 and 1920-2 (generically or collectively secondary conduit(s) 1920), each of which branches from the primary conduit 1910, and four tertiary conduits 1930-1, 1930-2, 1930-3, and 1930-4 (generically or collectively tertiary conduit(s) 1930), which branch from the secondary conduits 1920. These three categories of conduits may alternatively be referred to as primary supply conduits 1910, secondary supply conduits 1920, and tertiary supply conduits 1930, respectively. An upstream end 1911 of the primary conduit 1910 receives liquid coolant from the coolant source.

Each secondary conduit 1920 branches from, and is in fluid communication with, the primary conduit 1910. Moreover, each secondary conduit 1920-1, 1920-2 is associated with a respective a group G5, G6 of battery modules.

A pair of tertiary conduits 1930 branches from each of the secondary conduits 1920 respectively. Each tertiary conduit 1930 is fluidically coupled with the coolant inlet 148 of a respective one of the battery modules of the battery module group with which the secondary conduit 1920 is associated. In particular, the secondary conduit 1920 associated with battery module group G5 has two tertiary conduits 1930 branching therefrom, which are fluidically coupled with the coolant inlets 148 of battery modules BM9 and BM10 respectively. The other secondary conduit 1920 of FIG. 30 also has two tertiary conduits 1930 branching therefrom, which are associated with battery modules BM11 and BM12 respectively of battery module group G6. In the present embodiment, each tertiary conduit 1930 extends orthogonally from its secondary conduit 1920.

The structure of the coolant outlet manifold 2000 of FIG. 23 is analogous to that of coolant outlet manifold 1600 of FIG. 29. More specifically, the coolant outlet manifold 2000 is a tree-like network of three categories of conduits: a single primary conduits 2010, two secondary conduits 2020-1 and 2020-2 (generically or collectively secondary conduit(s) 2020), each of which branches from the primary conduit 2010, and four tertiary conduits 2030-1, 2030-2, 2030-3, and 2030-4 (generically or collectively tertiary conduit(s) 2030), which branch from the secondary conduits 2020. These may be referred to as primary return conduits 2010, secondary return conduits 2020, and tertiary return conduits 2030, respectively. A downstream end 2011 of the primary return conduit 2010 channels liquid coolant returning from the battery modules BM9-BM12 of battery module row R3 towards the coolant sink.

Each secondary return conduit 2020-1 and 2020-2 is associated with a respective one of battery module groups G5 and G6 comprising battery module row R3. Moreover, each secondary return conduit 2020 branches from, and is in fluid communication with, the primary return conduit 2010.

A pair of tertiary return conduits 2030 branches from each of the two secondary return conduits 2020 respectively. Each tertiary return conduit 2030 is fluidically coupled with the coolant outlet 150 of a respective one of the battery modules of the battery module group with which its secondary return conduit 2020 is associated.

The structure of the coolant inlet manifold 2100 of FIG. 30, which is associated with battery module row R4, is analogous to that of coolant inlet manifold 1900. The coolant inlet manifold 2100 comprises a single primary supply conduit 2110 having an upstream end 2111 and two secondary supply conduits 2120. The secondary supply conduits 2120 are each associated with a respective battery module group G7 and G8. The coolant inlet manifold 2100 further comprises four tertiary supply conduits 2130, each being associated with a respective one of battery modules BM13, BM14, BM15, and BM16.

Similarly, the structure of the coolant outlet manifold 2200 of FIG. 23 is analogous to that of coolant outlet manifold 2000. The coolant outlet manifold 2200 comprises a single primary return conduit 2210 and two secondary return conduits 2220 associated with battery module groups G7 and G8 respectively. The coolant outlet manifold 2200 further comprises four tertiary return conduits 2230, each being associated with a respective one of battery modules BM13, BM14, BM15, and BM16. In the present embodiment, each tertiary return conduit 2230 extends orthogonally from its secondary return conduit 2220. A downstream end 2211 of the primary return conduit 2210 channels liquid coolant returning from the battery modules BM13-BM16 of battery module row R4 towards the coolant sink.

The hierarchical nature of the coolant inlet manifolds 1500, 1700, 1900, and 2000, and the corresponding coolant outlet manifolds 1600, 1800, 2000, and 2200, respectively, may improve the uniformity of coolant fluid distribution to the battery modules BM1-BM16 through the creation of shorter coolant branches having their own associated downstream ends. The effect of coolant fluid momentum along the shorter secondary supply conduits 1520, 1720, 1920, and 2120 may be reduced compared to a longer supply conduit 220 (see FIG. 6), allowing for improved uniformity of coolant fluid distribution to the battery modules in each of the groups G1-G8.

In some embodiments, one or more of the coolant inlet manifolds 1500, 1700, 1900, and 2100 and/or the coolant outlet manifolds 1600, 1800, 2000, and 2200 may include flow restrictors such as those described above with reference to FIGS. 11-14. The flow restrictors may help to further improve the uniformity of coolant fluid distribution to the battery modules BM1-BM16 of FIGS. 29 and 30.

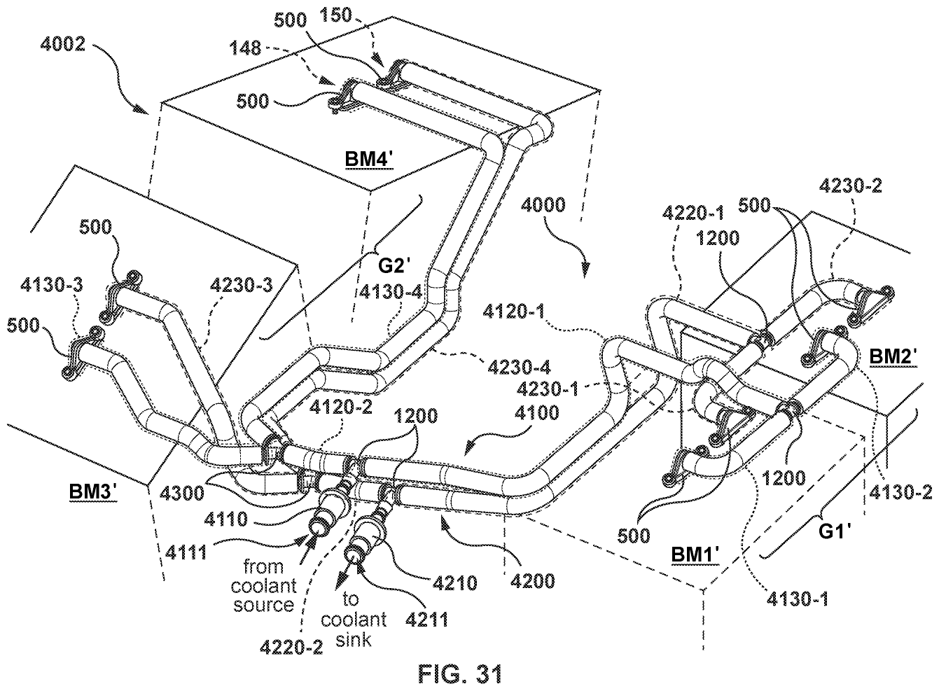

FIG. 31 depicts an alternative, simplified coolant manifold system 4000 that may be used with an alternative battery system 4002 for electric vehicle 1400 of FIG. 27. The alternative battery system 4002 is simplified in the sense that it has fewer battery modules (four) than in any of the above-described electric vehicle embodiments (sixteen). Each of the four battery modules BM1′, BM2′, BM3′, and BM4′ of FIG. 31 may incorporate more battery cells 144 (FIG. 4) per module (e.g., four times more), and may thus be larger, than any of the battery modules of any of the other embodiments described above. Each battery module BM1′-BM4′ has a single coolant inlet 148 and a single coolant outlet 150. Since the battery system 4002 has four times fewer battery modules than any previously described embodiment, there are four times fewer coolant inlets 148 to be supplied and four times fewer coolant outlets 150 from which coolant is to be returned. The structure of the coolant manifold system 4000 may accordingly be simplified in relation to above-described coolant manifold system embodiments.

For example, unlike the coolant manifold system 1406 of FIG. 28, which contains a total of four coolant inlet manifolds 1500, 1700, 1900, and 2100 and four coolant outlet manifolds 1600, 1800, 2000, and 2200, the coolant manifold system 4000 contains only a single coolant inlet manifold 4100 and a single corresponding coolant outlet manifold 4200. The sole coolant inlet manifold 4100 supplies coolant in parallel to all of the battery modules BM1′-BM4′ comprising battery system 4002, and the sole coolant outlet manifold 4200 channels coolant from all of the battery modules BM1′-BM4′ back to the coolant sink.

The battery modules BM1′ and BM2′ collectively form a first battery module group G1′, and battery modules BM3′ and BM4′ collectively form a second battery module group G2′. The battery modules of both groups G1′ and G2′ may be spaced further apart than the battery modules of any battery module groups described above. The battery modules of at least group G2′ might not be strictly arranged in a row in the present embodiment.

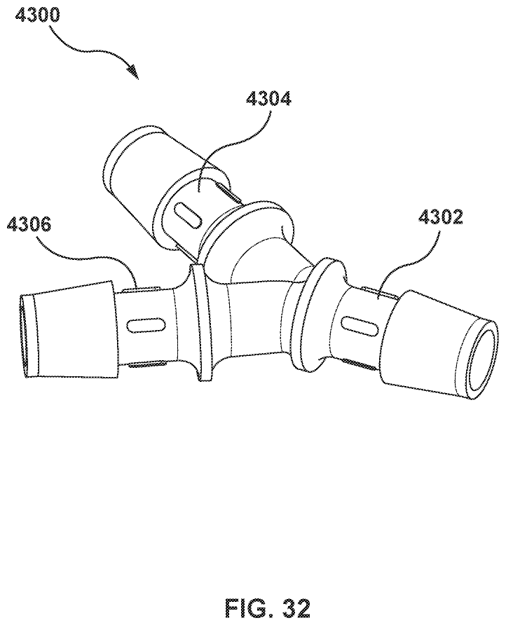

The coolant manifold system 4000 may be constructed from standard modular components, such as conduit sections 550, 1002, and 1004, end fittings 500, and through fittings 1200, described above. The present embodiment further includes a wye fitting (“Y” fitting, a form of splitter), which is shown in isolation in FIG. 32.

FIG. 32 illustrates the wye fitting 4300 in isometric view. The wye fitting 4300 has a straight trunk portion 4302 and two opposed straight branch portions 4304, 4306. Each of the branch portions 4304, 4306 branches extends at an angle of approximately 45 degrees with respect to an axis of trunk portion 4302, resulting in a general “Y” shape of fitting 4300. The internal passages defined by each of the portions 4302, 4304, and 4306 are in fluid communication with one another and are cylindrical in the present embodiment. The depicted wye junction fitting 4300 (splitter) divides fluid flowing through the trunk portion 4302 substantially evenly between the branch portions 4304, 4306. In alternative embodiments, the cross-sectional area of the splitter branch portions may differ. In such embodiments, the division of fluid between the splitter branch portions may be unequal.

Referring again to FIG. 31, the coolant inlet manifold 4100 has a tree-like, three-level hierarchy of supply conduits including one primary conduit 4110, two secondary conduits 4120-1 and 4120-2 (generically or collectively secondary conduit(s) 4120) that branch from the primary conduit 4110, and four tertiary conduits 4130-1, 4130-2, 4130-3, and 4130-4 (generically or collectively tertiary conduit(s) 4130), which branch from the secondary conduits 4120. These three categories of conduits may alternatively be referred to as primary supply conduits 4110, secondary supply conduits 4120, and tertiary supply conduits 4130, respectively.

An upstream end 4111 of the primary supply conduit 4110 receives liquid coolant from a coolant source. The primary supply conduit 4110 is terminated by first splitter, which in this case is a tee junction (through fitting 1200). The tee junction receives coolant via branch portion 1204 and divides the coolant flow substantially evenly between two secondary supply conduits 4120-1, 4120-2 fluidically coupled with respective ends of the run portion 1202. Each of the two secondary supply conduits 4120-1, 4120-2 is associated with a respective group G1′, G2′ of battery modules.

The first secondary supply conduit 4120-1 is terminated by a second splitter, which in this case is another tee junction (through fitting 1200). Two tertiary supply conduits 4130-1, 4130-2 branch from respective ends of the run portion 1202. Again, the through fitting 1200 is configured to divide fluid flow substantially evenly between the subordinate tertiary supply conduits 4130-1 and 4130-2. Distal ends of the tertiary supply conduits 4130-1 and 4130-2 are fluidically coupled with the coolant inlets 148 of battery modules BM1′ and BM2′ respectively.

The other secondary conduit 4120-2 of FIG. 31 is also terminated by a splitter, but in this case the splitter is a wye fitting 4300 rather than a tee junction. The two branch portions 4304 and 4306 of wye fitting 4300 receive substantially equal amounts of the coolant flowing into the trunk portion 4302 that flow into tertiary supply conduits 4130-3 and 4130-4 respectively. Distal ends of the tertiary conduits 4130-3 and 4130-4 are fluidically coupled with the supply inlets 148 of battery modules BM3′ and BM4′ respectively.

Similarly, the coolant outlet manifold 4200 has a tree-like, three-level hierarchy of supply conduits including one primary conduit 4210, two secondary conduits 4220-1 and 4220-2 (generically or collectively secondary conduit(s) 4220), which branch from the primary conduit 4210, and four tertiary conduits 4230-1, 4230-2, 4230-3, and 4230-4 (generically or collectively tertiary conduit(s) 4230), which branch from the secondary conduits 4220. These three categories of conduits may alternatively be referred to as primary return conduit 4210, secondary return conduits 4220, and tertiary return conduits 4230, respectively. An upstream end 4211 of the primary return conduit 4210 channels liquid coolant returning from the battery modules BM1′-BM4′ to a coolant sink.

Each of the two secondary return conduits 4220-1, 4220-2 is associated with a respective group G1′, G2′ of battery modules. The secondary return conduit 4220-1 terminates in tee junction (through fitting 1200) acting as an aggregator. Distal ends of the tertiary return conduits 4230-1 and 4230-2 branching from the splitter are fluidically coupled with the coolant outlets 150 of battery modules BM1′ and BM2′ respectively. The other secondary return conduit 4220-2 associated with battery module group G2′ is terminated by a wye fitting 4300 also acting as an aggregator. Distal ends of the two tertiary return conduits 4230-3 and 4230-4 branching from the aggregator are fluidically coupled to the coolant outlets 150 of battery modules BM3′ and BM4′ respectively.

Various alternative embodiments are possible.

In the foregoing description of restricted end fitting 800, the flow restrictor (constricted passage) is formed in the tubular portion 802 immediately upstream of the branch portion 804 of the end fitting 800. In an alternative embodiment, the flow restrictor could be defined in the branch portion 804 of the end fitting rather than in the upstream portion 802. In some embodiments, flow restrictors may also or instead be implemented in branch conduits other than a downstream-most branch conduit.

In some embodiments, a row of battery modules associated with a coolant inlet manifold may be oriented vertically (e.g., stacked) rather than horizontally as in FIG. 3. In such embodiments, the coolant supply conduit of the coolant inlet manifold may be oriented vertically rather than horizontally.

The coolant inlet manifolds 200, 900, 1000, 1500, 1700, 1900, 2100, and 4100 and the coolant outlet manifolds 300, 1100, 1600, 1800, 2000, 2200, and 4200 described above are illustrated as being substantially external to the battery modules with which they are associated. For example, several components of the coolant inlet manifold 200 and coolant outlet manifold 300 (e.g., the through fittings 400, end fittings 500 and conduit sections 550) are disposed adjacent to the external face 152 of the battery modules BM7-BM16. In some embodiments, at least a portion of coolant inlet and/or outlet manifolds may be internal to their associated battery modules. For example, battery modules may define integrated coolant conduits that form coolant inlet and/or outlet manifolds. These integrated coolant conduits may be formed by channels in frame elements (e.g., the casing or housing) of the battery modules. In some embodiments, a tapered inlet manifold defined by the frame elements of multiple stacked battery modules, which increases or reduces in cross-section from an upstream-most battery module to a downstream-most battery module, may provide a form of flow restriction to achieve the uniform coolant distribution discussed elsewhere herein.

At least some of the coolant inlet manifold and/or coolant outlet manifold embodiments described herein define “branching” of subordinate conduits from superordinate conduits as including “forking” (see precise definition above). It will be appreciated that, in some embodiments, the term “branching” may alternatively or additionally refer to the provision, by a subordinate conduit, of a sole egress channel from, or sole ingress channel into, an end of a superordinate conduit. For example, in FIG. 7, the branch portion 504 of end fitting 500 could alternatively be considered as a subordinate “branch conduit” branching from a superordinate conduit that terminates with the tubular portion 502 of end fitting just upstream of branch portion 504, despite the fact that branch portion 504 is not one of at least two conduits collectively defining a “fork.”

The size, shape, and positioning of the battery modules illustrated in the embodiments described herein are not limited. Optionally, the number of battery modules may change by combining the battery cells of several battery modules into one battery module, or by spitting the battery cells of one battery module into several battery modules. The structure of an associated thermal management system might change in accordance with the changing number of battery modules. By way of example, battery modules BM1-BM16 in the battery system 30′ of FIG. 20 might be replaced with four larger battery modules each containing four times the number of cells (e.g., battery modules BM1-BM4 form a first battery module, battery modules BM5-BM8 form a second battery module, battery modules BM9-BM12 form a third battery module, and battery modules BM13-BM16 form a fourth battery module). These larger battery modules may be similar to the battery modules BM1′-BM4′ of FIG. 31, for example. In this way, the battery system 30′ may have the same battery capacity while using four times less battery modules. The coolant manifold system 115′ might change in accordance with the reduced number of battery modules. For example, the number of primary conduits, secondary conduits and tertiary conduits may vary as compared to the embodiment illustrated in FIG. 20.

What is claimed is:

1. An electric vehicle comprising:
a plurality of battery modules, each of the battery modules having a respective coolant inlet;
a coolant source;
a coolant inlet manifold configured to supply coolant from the coolant source to each of the plurality of coolant inlets in parallel, the coolant inlet manifold including:
a coolant supply conduit terminating at a downstream end;
a plurality of branch conduits branching from, and in fluid communication with, the coolant supply conduit, each of the branch conduits being fluidically coupled to the coolant inlet of a respective one of the battery modules; and
a plurality of flow restrictors each restricting coolant flow to a respective subset of the branch conduits.

2. The electric vehicle of claim 1 wherein the plurality of battery modules is arranged in a row.

3. The electric vehicle of claim 1 wherein each of the flow restrictors is disposed in the coolant supply conduit.

4. The electric vehicle of claim 3 wherein each of the flow restrictors restricts coolant flow to the respective subset of the branch conduits branching from the coolant supply conduit downstream of the flow restrictor.

5. The electric vehicle of claim 3 wherein each of the flow restrictors, excluding a downstream-most one of the flow restrictors, directs a portion of the coolant flow to a respective one of the branch conduits branching from the coolant supply conduit upstream of the flow restrictor.

6. The electric vehicle of claim 3 wherein each of the flow restrictors is configured to restrict a flow of liquid coolant to a respective extent and wherein the extent to which each of the flow restrictors is configured to restrict the flow of liquid coolant monotonically increases in the downstream direction along the coolant supply conduit.

7. The electric vehicle of claim 3 wherein one of the plurality of flow restrictors is configured to restrict liquid coolant flow into or through a downstream-most one of the branch conduits at the downstream end of the coolant supply conduit and wherein each of a remainder of the flow restrictors is configured to restrict liquid coolant flow in the coolant supply conduit immediately downstream of a respective other one of the branch conduits.

8. The electric vehicle of claim 7 wherein the downstream-most one of the branch conduits comprises a branch portion of an end fitting and wherein the one of the plurality of flow restrictors is disposed in a tubular portion of the end fitting upstream of the branch portion of the end fitting.

9. The electric vehicle of claim 8 wherein the end fitting is a 90-degree elbow fitting.

10. The electric vehicle of claim 7 wherein, for each of the remainder of the flow restrictors:
the flow restrictor defines a constricted passage in the coolant supply conduit immediately downstream of a respective one of the branch conduits; and
the coolant supply conduit defines an unconstricted passage immediately upstream of the respective one of the branch conduits,
a cross-sectional area of the constricted passage being smaller than a cross-sectional area of the unconstricted passage.

11. The electric vehicle of claim 1 wherein each of the flow restrictors is disposed in, and restricts liquid coolant flow through, a respective one of the branch conduits.

12. The electric vehicle of claim 11 wherein the extent to which each of the flow restrictors is configured to restrict liquid coolant flow monotonically decreases in the downstream direction along the coolant supply conduit.

13. The electric vehicle of claim 1 wherein the coolant supply conduit is substantially straight.

14. The electric vehicle of claim 13 wherein each of the branch conduits is substantially orthogonal to the coolant supply conduit.

15. An electric vehicle comprising:
a plurality of battery modules, each of the battery modules having a respective coolant inlet, the plurality of battery modules being grouped in multiple groups of at least two battery modules per group;
a coolant source;
a coolant inlet manifold configured to supply coolant from the coolant source to each of the plurality of coolant inlets in parallel, the coolant inlet manifold including:
a primary conduit in fluid communication with the coolant source;
a plurality of secondary conduits branching from, and in fluid communication with, the primary conduit, each of the secondary conduits being associated with a respective one of the groups of battery modules; and
for each of the secondary conduits, a plurality of tertiary conduits branching from, and in fluid communication with, the secondary conduit, each of the tertiary conduits of the plurality being fluidically coupled with the coolant inlet of a respective one of the battery modules of the group with which the secondary conduit is associated.

16. The electric vehicle of claim 15 wherein the plurality of battery modules is arranged in a row.

17. The electric vehicle of claim 16 wherein each group of battery modules is a distinct, contiguous plurality of battery modules within the row.

18. The electric vehicle of claim 15 wherein, for each of the secondary conduits, the tertiary conduits branching from the secondary conduit are each substantially orthogonal to the secondary conduit.

19. The electric vehicle of claim 15 wherein the plurality of secondary conduits comprises two secondary conduits and the primary conduit is fluidically coupled to the two secondary conduits via a splitter.

20. The electric vehicle of claim 19 wherein the splitter is configured to divide fluid flow from the primary conduit substantially evenly between the two secondary conduits.

21. The electric vehicle of claim 15 wherein, for each of the secondary conduits, the plurality of tertiary conduits branching from the secondary conduit comprises two tertiary conduits and the secondary conduit is fluidically coupled to the two tertiary conduits via a splitter.

22. The electric vehicle of claim 21 wherein, for each of the secondary conduits, the splitter is configured to divide fluid flow from the secondary conduit substantially evenly between the two tertiary conduits.

23. The electric vehicle of claim 15 wherein the primary conduit is a primary supply conduit, wherein each of the secondary conduits is a secondary supply conduit, wherein each of the tertiary conduits is a tertiary supply conduit, wherein each of the plurality of battery modules has a respective coolant outlet, and further comprising:
a coolant sink;
a coolant outlet manifold configured to channel liquid coolant to the coolant sink from each of the plurality of coolant outlets in parallel, the coolant outlet manifold including:
a primary return conduit in fluid communication with the coolant sink;
a plurality of secondary return conduits branching from, and in fluid communication with, the primary return conduit, each of the secondary return conduits being associated with a respective one of the groups of battery modules; and
for each of the secondary return conduits, a plurality of tertiary return conduits branching from, and in fluid communication with, the secondary return conduit, each of the tertiary return conduits of the plurality being fluidically coupled with the coolant outlet of a respective one of the battery modules of the group with which the secondary return conduit is associated.

24. An electric vehicle comprising:
a plurality of battery modules, each of the battery modules having a respective coolant inlet;
a coolant source;
a coolant inlet manifold configured to supply coolant from the coolant source to each of the plurality of coolant inlets in parallel, the coolant inlet manifold including:
a primary conduit in fluid communication with the coolant source;
a plurality of secondary conduits fluidically coupled to the primary conduit via a first splitter; and
for each of the secondary conduits, a plurality of tertiary conduits fluidically coupled to the secondary conduit via a respective second splitter, each of the tertiary conduits of the plurality being fluidically coupled with the coolant inlet of a respective one of the battery modules.
